(19) United States
(12) Patent Application Publication
(10) Pub. No.: US 2014/0244318 A1
(43) Pub. Date: Aug. 28, 2014

(54) SYSTEM AND METHOD FOR COLLECTING AND ASSESSING WILDFIRE HAZARD DATA*

(71) Applicant: Wildfire Defense Systems, Inc., Red Lodge, MT (US)

(72) Inventors: Robert Drake, Bozeman, MT (US); Dave Torgerson, Red Lodge, MT (US); Joshua Amidon, Bozeman, MT (US); Eric Barnes, Bozeman, MT (US); Tyler Cross, Bozeman, MT (US); Casey Zaiko, Bozeman, MT (US); Nick Lauria, Bozeman, MT (US); Bradly Jay Billman, San Antonio, TX (US); Wayne Hartman, San Antonio, TX (US); Arti Bhide, San Antonio, TX (US); Charles L. Oakes, III, Boerne, TX (US); Elizabeth Ruben, San Antonio, TX (US); Mark Zuwala, San Antonio, TX (US); Emily Gray, San Antonio, TX (US); Sandra Sausman, San Antonio, TX (US)

(73) Assignee: Wildfire Defense Systems, Inc., Red Lodge, MT (US)

(21) Appl. No.: 14/276,397

(22) Filed: May 13, 2014

Related U.S. Application Data
(63) Continuation-in-part of application No. 13/678,301, filed on Nov. 15, 2012.
Application No. 13/678,301 is a continuation-in-part of application No. 13/678,308, filed on Nov. 15, 2012, now Pat. No. 8,760,285.
Application No. 13/678,308 is a continuation-in-part of application No. 13/828,089, filed on Mar. 14, 2013.

(51) Int. Cl. G06Q 40/08

(52) U.S. Cl. CPC G06Q 40/08
USPC 705/4

(57) ABSTRACT

A computer-implemented system for collecting and assessing wildfire hazard data comprising a mobile device with an application installed on the mobile device for on-site collection of wildfire hazard data and a wildfire risk assessment provider server. The data collected on the mobile device is merged with data at the wildfire risk assessment provider server to produce underwriting risk scores and reports for insurers, education-aimed recommendations and reports for policyholders, wildfire risk alerts for mobile device application users, strategies for client-to-policyholder wildfire awareness communication, and strategies for wildfire response teams used to drive pre-suppression and active fire actions. A method utilizing the system described above.

### CROSS-REFERENCE TO RELATED APPLICATION

This application is a continuation-in-part of U.S. patent application Ser. No. 13/678,301 filed on Nov. 15, 2012, U.S. patent application Ser. No. 13/678,308 filed on Nov. 15, 2012, and U.S. patent application Ser. No. 13/828,089 filed on Mar. 14, 2013. The contents of the latter applications are incorporated heroin by reference.

### BACKGROUND OF THE INVENTION

1. Field of the Invention

The present invention relates generally to the field of computer-implemented inventions, and more specifically, to a system and method for collecting and assessing wildfire hazard data, merging this data with various wildfire risk calculation variables, and generating wildfire risk valuations and mitigation recommendations.

2.Description of the Related Art

Currently in the home and property wildfire risk inspection environment, insurers conduct wildfire hazard assessments to gather wildfire hazard assessment data, which includes property photos, notes detailing associated risk(s), time, date, assessor, and other general background information associated with a given property assessment. The insurers might complete this data collection using their own trained assessment staffer work with a wildfire risk assessment provider to gather it for them. Gathered property site data can be used (a) for properly underwriting purposes, which has a goal of accurately identifying wildfire risk value so that insurance rates can be properly set, (b) for policyholder education purposes, with a goal of motivating policyholders to take recommended actions to reduce wildfire risk around their property, and/or (c) to guide wildfire response actions in a wildfire event.

In the most common scenario, wildfire hazard data collectors drive from home to home, gathering information lot wildfire risk and mitigation strategy reports using a pen and paper, laptop, handheld/truck GPS, and handheld camera. This data is then uploaded to a wildfire risk assessment provider or insurance client office server, where it is organized manually into a report. This report may take the form of a Microsoft Publisher document for example. Processing of the report follows client-defined rules, and report accuracy is often limited to the expertise of the data collector, who may or may not have a wildfire risk education background. This report is usually not reviewed by anyone with any wildfire risk expertise, as client office staff may have limited to no wildfire background, and essential elements of the risk puzzle—namely, location-based risk factors and updated wildfire activity—are not included in the assessment of property risk.

Organizing data collection staff as they move from property to property to collect site data is expensive and requires near constant hotel accommodations, flights to and from the assessment area, and gas to support vehicle travel. This comes with its own set of risks, including driving accidents and injury to personnel. Field assessors are repaired to be away from home for weeks at a time, which results in high levels of turnover, rehiring, and retraining. Hardware and software required to perform the data collection is expensive, is not always reliable or consistent, and is not always maintained, resulting in data loss or loss in data quality.

In addition, collecting and organizing data from the field into a predefined format is time-consuming, tedious, and susceptible to errors, not the least of which is lost or missing data, which may require the assessor to return to the home and/or result in incomplete reports and additional expenses or monetary fines incurred when client contract expectations are not met as a result. Processing time to bring data from its inception at the home site to a completed report in the hands of the client is long, as numerous days are lost to processing submitted data, researching/requesting missing data, organizing data, and sending the data back to the client. Each step of the process—collecting, organizing, maintaining, and updating inspection data—is tedious, time-consuming, and error-prone. Errors or delays in data collection and organization can also result in an incorrect risk assessment that not only negatively impacts home/property safety but also falsely conveys risk to insurers writing policies a round the risk assessment.

With conventional methods, the data collected is often incomplete; although this data may take into account wildfire risks around the property, it often does not include area/location-based risk factors, including wildfire history, recent past and current climate conditions, general area topography, home density, neighborhood wildfire safety preparedness, etc. It often relies on incomplete location-based risk assessment data that operates too broadly (at the land parcel level) and is devoid of known wildfire risk factors such as recent climate/weather condition (including sustained drought, seasonality neighborhood density effect, etc.). More importantly, it misses actual present day wildfire fuel lead and densities, which may markedly differ from past wildfire fuel load and densities due to significant changes in urban growth or recent wildfire.

Wildfire fuels around the property and immediate surroundings are often analyzed in isolation rather than comprehensively, and thus the fuel continuity/density picture so vital to properly assessing wildfire movement may not be fully fleshed out. It rarely takes late account updated wildfire risk, which includes known wildfire “red flag warnings” indicating area ripeness for a wildfire, active fire activity and proximity, planned proscribed burns, and more. Finally, there is run a method by which insurers or their policyholders are able to bring all these risk factors together—location-based risk, site-based risk, and updated wildfire risk—in a single, integrated wildfire risk analysis.

What is needed is a system and method for collecting wildfire risk assessment data in the field and merging it with location-based risk data and known updated wildfire risk data to provide a comprehensive, integrated wildfire risk valuation that would drive mitigation efforts, response actions, and insurance policy valuations. The present invention meets ail of these requirements, as described more fully below.

### BRIEF SUMMARY OF THE INVENTION

The present invention is a computer-implemented system for collecting and assessing wildfire hazard data comprising: a mobile device with an application installed on the mobile device for on-site collection of wildfire hazard data; and a wildfire risk assessment provider server; wherein data collected on the mobile device is merged with data at the wildfire risk assessment provider server to produce underwriting risk scores and reports for insurers, education-aimed recommendations and reports for policyholders, wildfire risk alerts for mobile device application users, strategies for client-to-policyholder wildfire awareness communication, and strategies for wildfire response teams used on drive pre-suppression and active fire actions.

In a preferred embodiment, the merging of the data collected on the mobile device with data at the wildfire risk assessment provider server is accomplished via the application of a site-based risk algorithm that calculates a site-based risk total based on affirmative answers to wildfire risk assessment condition questions, a location-based risk algorithm that computes a location-based risk value based on a multitude of wildfire risk factors known to impact a site's potential for wildfire ignition, a level of service algorithm that generates a level of service score based on the site-based risk total and the location-based risk value, an updated wildfire risk algorithm that multiplies the location-based risk value by an updated wildfire risk multiplier to determine an updated wildfire risk value, and an integrated wildfire risk algorithm that multiplies the site-based risk total, the location-based risk value, and the updated wildfire risk multiplier by each other to produce an integrated wildfire risk score.

The present invention is also a computer-implemented method for collecting and assessing wildfire hazard data comprising: selecting properties for which an assessment needs to be completed; providing a mobile device on which is installed an application for collecting wildfire hazard assessment data; applying a site-based risk algorithm, to the collected wildfire hazard assessment data to calculate a site-based risk total; using a location-based risk algorithm to generate a location-based risk value, wherein, the location-based risk value is determined by computing a multitude of wildfire risk factors known to impact a site's potential for wildfire ignition; and using a level of service algorithm to multiply the site-based risk total by the location-based risk value to generate a level of service score. Optionally, the method further comprises the step of using an integrated wildfire risk algorithm to multiply the site-based risk total, the location-based risk value, and the updated wildfire risk multiplier by each other to generate an integrated wildfire risk score.

In an alternate embodiment, the present invention is a computer-implemented method for collecting and assessing wildfire hazard data comprising: using a location-based risk algorithm to generate a location-based risk value, wherein the location-based risk value is determined by computing a multitude of wildfire risk factors known to impact a site's potential for wildfire ignition; and using an updated wildfire risk algorithm to multiply the location-based risk value by an updated wildfire risk multiplier to generate an updated wildfire risk value.

In a preferred embodiment, the level of service score is used to determine a course of action to be taken by wildfire risk assessment provider staff. Preferably, the integrated wildfire risk score is used to produce underwriting risk scores and reports for insurers, education-aimed recommendations and reports for policyholders, wildfire risk alerts for mobile device application users, strategies for client-to-policyholder wildfire awareness communication, and strategies for wildfire response teams used to drive pre-suppression and active fire actions. The method preferably further comprises providing summary and recommendation screens that are returned to the mobile device application.

### BRIEF DESCRIPTION OF THE DRAWINGS

FIG. 1 is a diagram of the system architecture of the present invention.

FIG. 2 is a flow diagram of the user application.

FIG. 3 is a flow diagram of the wildfire risk assessment provider server application.

FIG. 4 is a flow diagram of the wildfire risk assessment provider server functions.

FIG. 5 is a use flow diagram of the mobile device application.

FIG. 6 is a screenshot of the web interface manage reports screen.

FIG. 7 is a screenshot of the web interface update report screen.

FIG. 8 is a screenshot of the web interface metrics screen.

FIG. 9A is an example of a wildfire hazard assessment checklist.

FIG. 9B is a continuation of FIG. 9A.

FIG. 9C is a continuation of FIG. 9B.

FIG. 12 is a diagram of the level of service algorithm used in the present invention.

FIG. 13 is a screenshot of the registration code entry screen.

FIG. 14 is a screenshot of the no registration code screen.

FIG. 15 is a screenshot of the account creation screen.

FIG. 16 is a screenshot of the property selection screen.

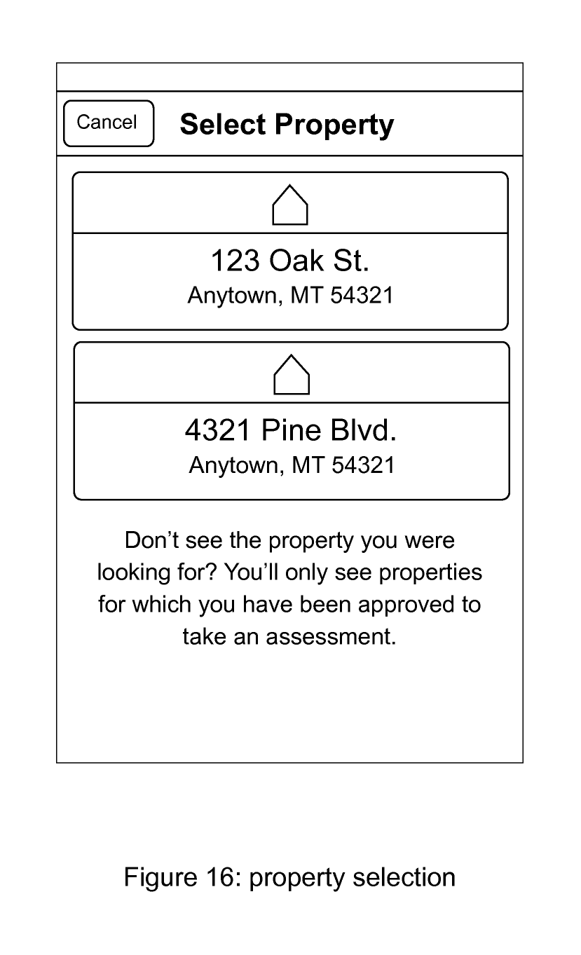

FIG. 17 is a screenshot of the start new assessment screen.

FIG. 18 is a screenshot of the assessment dashboard screen.

FIG. 19 is a screenshot of the assessment dashboard screen with dynamic data.

FIG. 20 is a screenshot of the data collection screen.

FIG. 21 is a screenshot of the help screen.

FIG. 22 is a screenshot of the photo taking instruction screen.

FIG. 23 is a screenshot of the photo capture screen.

FIG. 24 is a screenshot of the photo preview screen.

FIG. 25 is a screenshot of the photo gallery screen.

FIG. 26 is a screenshot of the dashboard with submit button screen.

FIG. 27 is a screenshot of the successful submission alert box.

FIG. 28 is a screenshot of the recommendations menu screen.

FIG. 29 is a screenshot of the summary screen.

FIG. 30 is a screenshot of the recommendation detail screen.

FIG. 31 is a screenshot of the learn more menu screen.

FIG. 32 is a screenshot of the learn more content screen displaying a wildfire video.

FIG. 33 is a screenshot of the learn more content screen displaying a fire triangle article.

FIG. 34 is a screenshot of the updated wildfire risk screen.

FIG. 35 is s screenshot of the location-based risk screen.

FIG. 36 is a screenshot of the integrated wildfire risk screen.

FIG. 37 is a screenshot of the multiple structure/commercial property screen.

FIG. 38 is a screenshot of the updated wildfire risk indicator screen.

FIG. 39 is a screenshot of the updated risk indicators zoom and export view screen.

FIG. 40 is a screenshot of the assisted risk indicator's pin view screen.

FIG. 41 is a sample .pdf export report from the updated risk indicator.

FIG. 42 is a screenshot of the push notification indicator screen.

FIG. 43 is a screenshot of the push notification high level message alert screen.

FIG. 44 is a screenshot of the push notification alert details screen.

FIG. 45 is a diagram of the relationships among the various algorithms used in the present invention.

FIG. 46 is a diagram of the site-based risk algorithm.

FIG. 47 is a site vulnerability diagram.

FIG. 48 is diagram of the location-based risk algorithm.

FIG. 49 is a diagram of the updated wildfire risk algorithm.

FIG. 50 is a diagram of the integrated wildfire risk algorithm.

FIG. 51 is a diagram of the updated wildfire risk breakout.

### DETAILED DESCRIPTION OF INVENTION

### A. Overview

The present invention is a system and method for collecting wildfire risk inspection data in the field at the property/home site using a mobile device application; upon submission, this data is merged with data at the wildfire risk assessment provider server to produce various wildfire safety outputs, including underwriting risk scores/reports for insurers (used to drive policy decisions), education-aimed recommendations/reporting for policyholders (used to drive mitigation actions), wildfire risk alerts for mobile device application users (used to aid preparedness efforts for both client/insurer users and their policyholders), strategies for client-to-policyholder wildfire awareness communication (used to provide detailed updates and recommendations for preparedness), and strategies for wildfire response teams (used to drive pre-suppression and active fire actions). This functionality is achieved using a number of algorithmic calculations, which may be used independently or in combination: (1) the site-based risk algorithm. (2) location-based risk algorithm, (3) level of service algorithm, (4) updated wildfire risk algorithm, and (5) integrated wildfire risk algorithm. Each of these algorithms is discussed more fully below.

The present invention uses a mobile device application for collecting wildfire hazard assessment data (referred to herein as “site-based data”) for insurance industry clients and then merges this site-based data with location-based data and updated wildfire risk data to generate various outputs, including, but not limited to, underwriting reports, education reports, risk ratings for various claims reduction and wildfire loss/safety purposes. These outputs are discussed more fully below.

The site-based data collected includes properly photos, notes detailing associated risk(s), time, date, assessor, and other general background information associated with a given property assessment. Users of the mobile device application are typically trained insurance industry staff or a policyholders, as further described below. This type of user collects wildfire hazard assessment data at policyholder properties as prompted by the mobile device application and sends this data to the wildfire risk assessment provider server for analysis. Once the data is analyzed by wildfire risk assessment provider staff and/or auto-analytics (algorithm calculation logic, specifically, algorithm numbers (1), (2) and (3) above), a final report constituting the wildfire hazard assessment is sent to the insurer and/or the policyholder. This report has one of two outputs: underwriting use case and education use case.

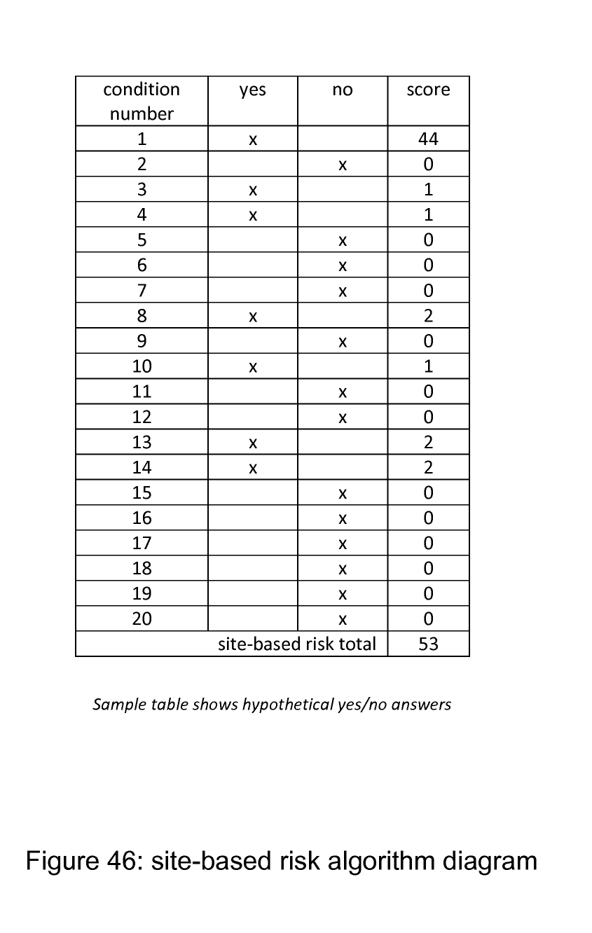

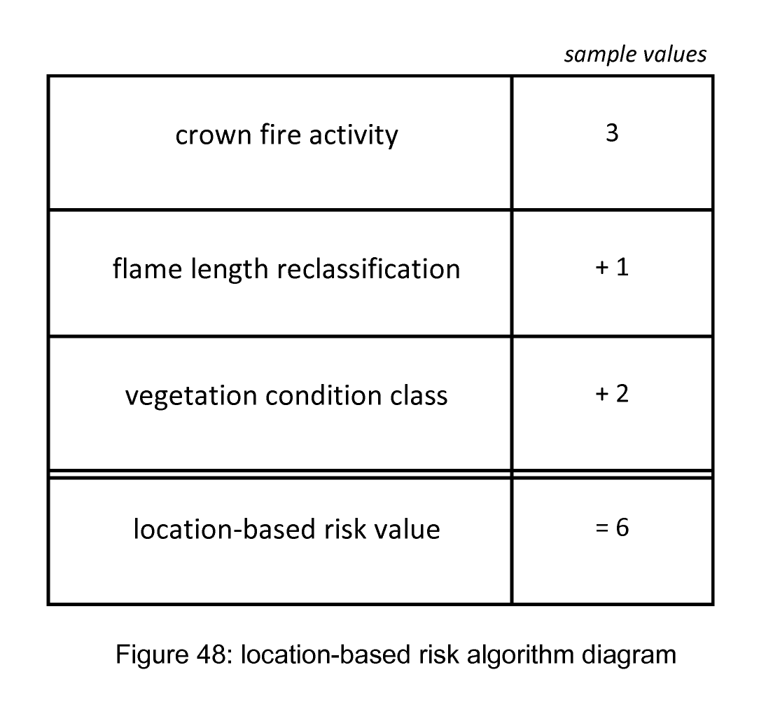

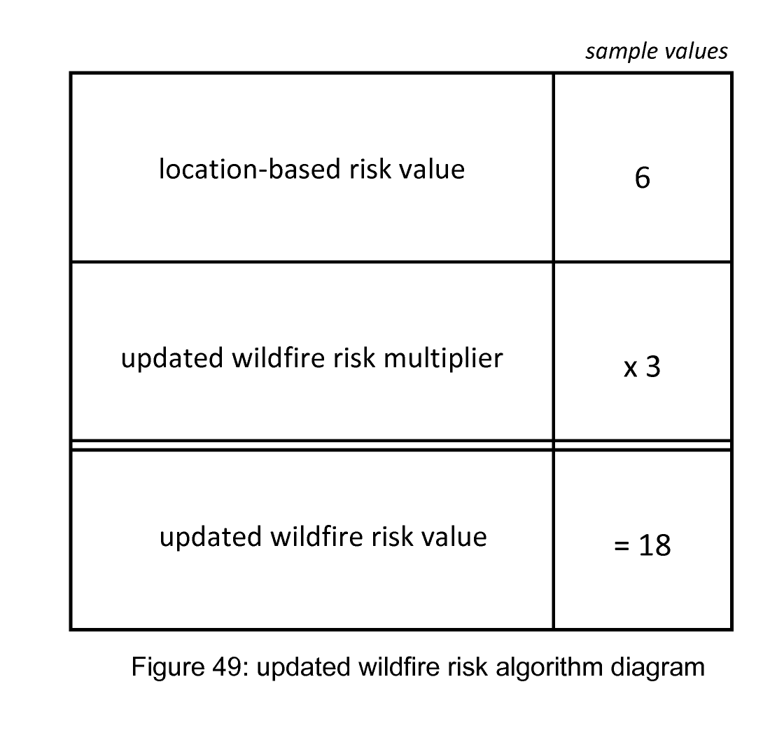

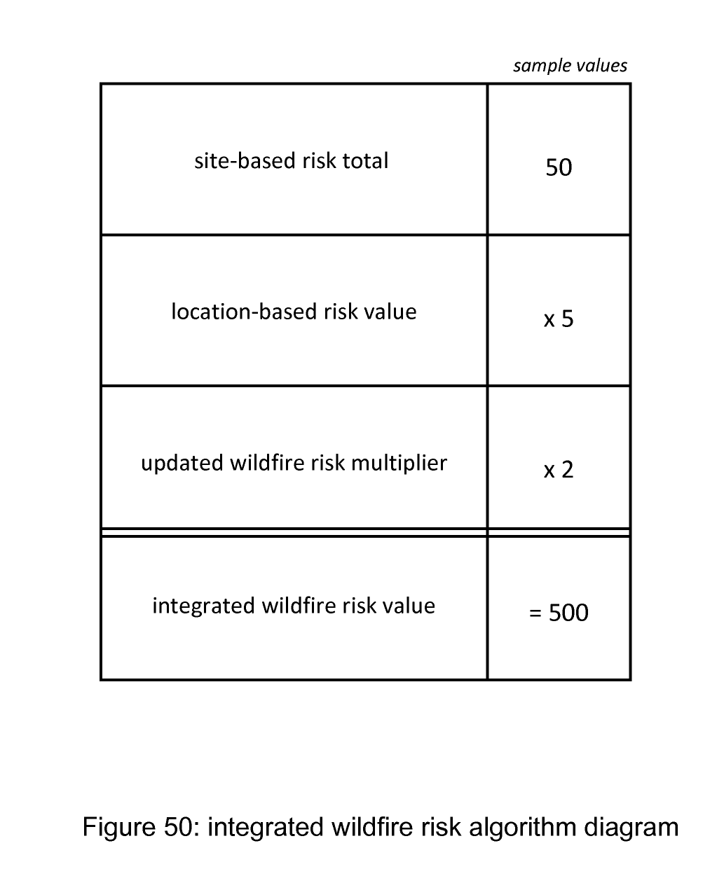

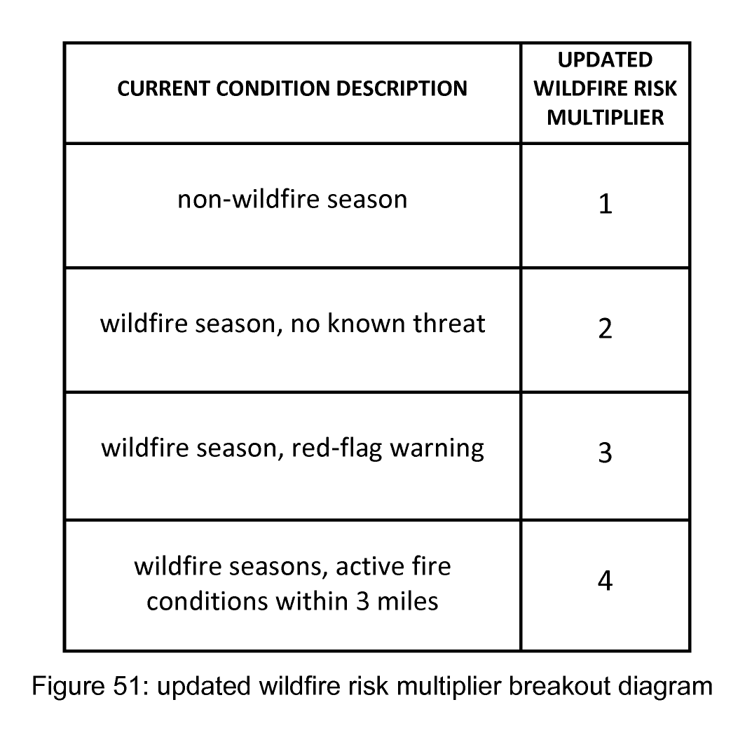

In the underwriting use case, insurance clients employ trained staff to complete the wildfire hazard assessment data collection process and submit it to a wildfire risk assessment provider server for analysis. Once the data hits the wildfire risk assessment provider server, it is immediately processed by the level of service algorithm, which defines what actions, if any, the wildfire risk assessment provider takes to further process the data. Based on level of service rules, a final report is generated and sent to the insurer office. Report output is points-based and is aimed at correctly setting policyholder insurance rates based on confirmed wildfire hazard risks. The level of service algorithm is a calculation that multiplies the site-based risk total (see FIG. 46) and location-based risk value (see FIG. 48) to generate a level of service score. The location-based risk value is multiplied by the updated wildfire risk multiplier (see FIG. 51) to generate an updated wildfire risk value (see FIG. 49). The site-based risk total, location-based risk value, and updated wildfire risk, multiplier are multiplied to generate the integrated wildfire risk score (see FIG. 50), which can be used to define wildfire risk assessment provider recommendations, client actions, response actions, etc. All wildfire risk values can serve as a basis for underwriting policy rate decisions.

In the education use case, insurance agency staff wildfire risk assessment provider staff, or the policyholders themselves complete the wildfire hazard assessment data collection process and submit the data to the wildfire risk assessment provider server for analysis. As in the underwriting use case, this data is immediately processed by the level of service algorithm to define what actions, if any, the wildfire risk assessment provider will take to further process the data. Based on level of service rules, a final report is generated and sent to the client/insurer office and/or the policyholders mobile device. Although the level of service algorithm does generate a level of service score and an integrated wildfire risk score, these values are not included in the report output in the education use case. Instead, the report output includes a write-up with recommended actions the policyholder should take to reduce wildfire threat around his property. As with the underwriting use case, the level of service score (which is the site-based risk total multiplied by the location-based risk value) is multiplied by an updated wildfire risk, value to generate an integrated wildfire risk score that defines wildfire risk assessment provider recommendations (see FIG. 50).

As used herein, the terms “home” and “property” should be construed to include any structure/structure type or material possession included on the property, as these are all items that are included in a wildfire hazard assessment. These terms are also meant to include vegetation on a given property. As used herein, the terms “client” most typically refers to an insurer but could include any business organization or individual doing business with the wildfire risk assessment provider. As used herein, the term “wildfire risk assessment provider” refers to a wildfire risk assessment business organization that supports a client's wildfire risk assessment process. As used herein, the term “user” refers to anyone using the mobile device application. In most cases, this is art untrained policyholder or a trained staff member working for the insurer or the wildfire risk assessment provider.

### B. Detailed Description of the Figures

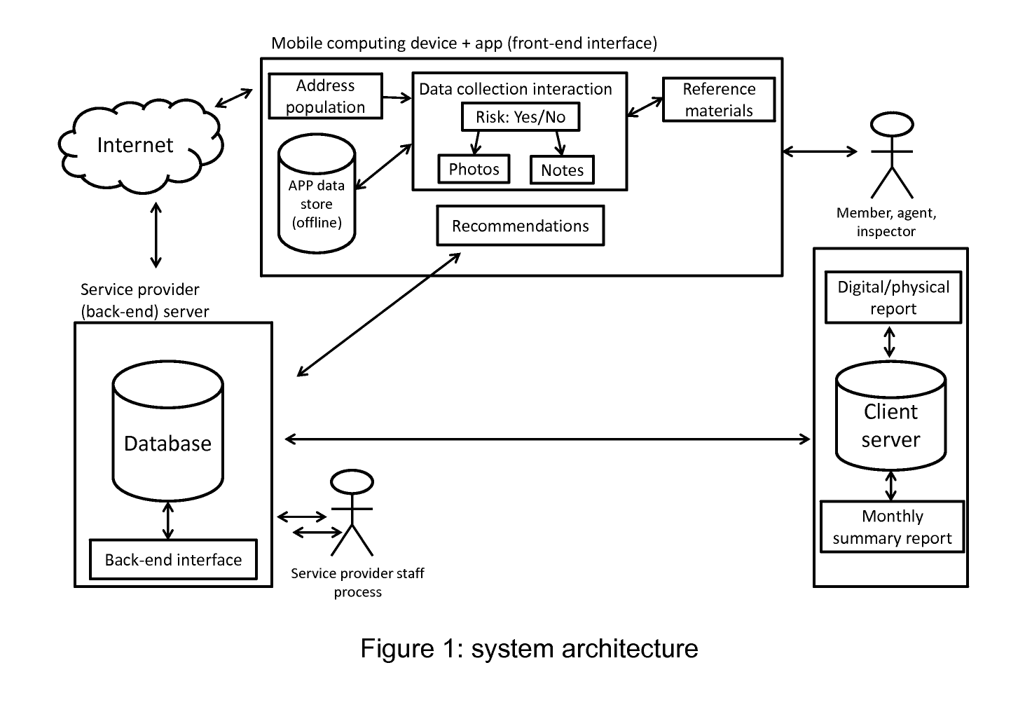

FIG. 1 is a diagram of the system architecture of present invention. The data collection process occurs on a mobile device that has an installed version of the mobile device application.

In a preferred embodiment users (as previously defined, these are most commonly either client-paid data collection staff in an underwriting use case, or client policyholders in an education use case) are pre-approved for mobile device application use at the wildfire risk assessment provider server, which means that their property address is entered into the database and then specified to be “offered” and “allowed” to take an assessment. This address population occurs after the user (a) enters a valid registration code into the application and (b) creates a user account that is validated at the wildfire risk assessment provider server. Both of these security checks require communication with the wildfire risk assessment provider server; successful completion of these two items unlocks the version of the mobile device application specific to that user.

At this point, the user selects the address(es) available and proceeds through the data collection process as prompted. This consists of answering “Yes” or “No” risk indication questions and attaching photos and notes as required. Users can get help information from the mobile device application by tapping the “Not Sure” button, tapping the help icons, or visiting the “Learn More” section. The question set users process through is provided by the client during the development of the mobile device application, and all data collection requirements—including required photos, number of photos required per condition, note-taking requirements, etc.—are defined by the client as well. Once all questions have been answered to the required level of completion, the user is able to submit the assessment information to the wildfire risk assessment provider server. Once this information hits the wildfire risk assessment provider server, it processes through the level of service algorithm, which defines whether the report creation is automated or analyzed by wildfire risk assessment provider staff. Next, a final report is generated and sent back to the user's mobile device and/or client server.

Call from the mobile device application to the wildfire risk assessment provider server occur wirelessly several times throughout the process: (a) registration code entry; (b) account creation; (c) welcome introduction screen, if applicable for the user type; (d) receipt of a report from the wildfire risk assessment provider server; (e) user login; (f) password reset; (g) scheduling of an appointment to review a returned report; and (h) viewing of certain help screens and/or videos. All other mobile device application processing—that is, the data collection itself, including all answers to questions, photo and note attachments, etc.—is stored internally on the mobile device, with progress stored there as well so that the user can leave the mobile device application and return wherever he left off. The data submitted by the user to the wildfire risk assessment provider server is displayed in a web interface accessible to wildfire risk assessment provider staff. This interface allows this data to be validated, revised or queried before being returned to the user and/or client.

Completed reports can be viewed on the user's mobile device and/or as a downloadable and printable report in the form of a MICROSOFT WORD™ document, ADOBE ACROBAT™.pdf tile, or both. Summary detail comes in the from of combinations of wildfire risk assessment provider staff-generated summary write-up and pre-created verbiage recommendations, which reflect best practices in the realm of wildfire risk.

In a preferred embodiment, once the report has been returned to the mobile device/client server, the number of assessments allowed for that address is decremented, normally resulting in a zero value, which means that the address cannot be reassessed; however, the ability to reassess a given property can be granted by special request from the client. Additionally, wildfire risk assessment provider staff are able to revise a given report by changing end resaving the report using the web interface as needed. Once a user logs back into his account on the mobile device, the updated report will be downloadable and available to view.

Referring to FIG. 1, the user is either (a) a client policyholder, which most typically indicates an education use case, or (b) a trained staff for the client which most typically indicates an underwriting use case. Both user types will receive messaging that indicates successful or failed wildfire risk assessment provider server interactions, and this messaging occurs when data has been returned to either the mobile device or the client server.

Data for a given report is archived at the wildfire risk assessment provider server and can be viewed at any given time using basic search functionality. Additionally, the data can be used to generate “sort-by-date” reporting for the client, most typically in the form of monthly reports that consolidate all user activity that occurred. This can be used to validate billing, research property patterns/concerns, and audit processes to ensure accuracy.

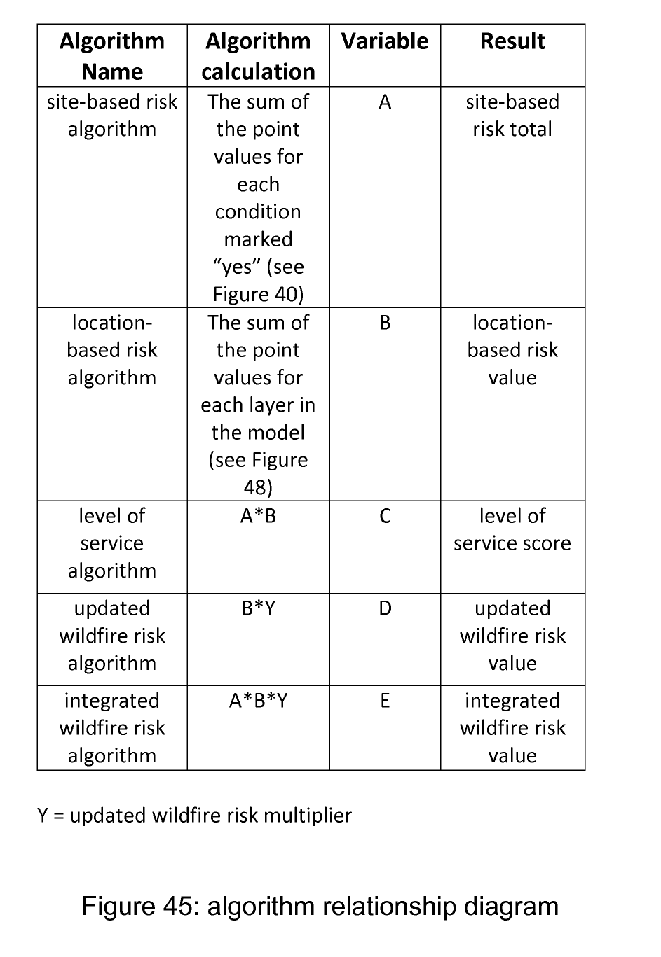

FIG. 45 is an algorithm relationship diagram, which shows how data gathered in the field processes through five algorithms (alone or in combination) and how the algorithms internet to produce a given wildfire risk value.

The site-based risk algorithm (“A” an FIG. 45) produces a total of all “Yes” (“wildfire risk is present” for the condition in question) answers to wildfire risk assessment condition questions. This total is calculated when the user successfully submits a wildfire risk assessment to the wildfire risk assessment provider server; this site-based risk total can be changed by wildfire risk assessment provider staff after analysis, or, in some cases, it is not changed because the report output is automated or the site-based risk “Yes” conditions are validated by wildfire risk assessment provider staff. The site-based risk algorithm is more fully detailed below in FIG. 46.

Upon reception at the wildfire risk assessment provider server, the site-based risk total is multiplied by the location-based risk value, which is a value generated by the location-based risk algorithm (see “B” on FIG. 45). This location-based risk value is associated with the address in the wildfire risk assessment provider database and is generated using an algorithm that incorporates the 40 Scott and Burgan fire behavior fuel models (http://www.landfire.gov/National/ProductDescriptions2.php). The location-based risk value is more fully detailed in FIG. 48 below.

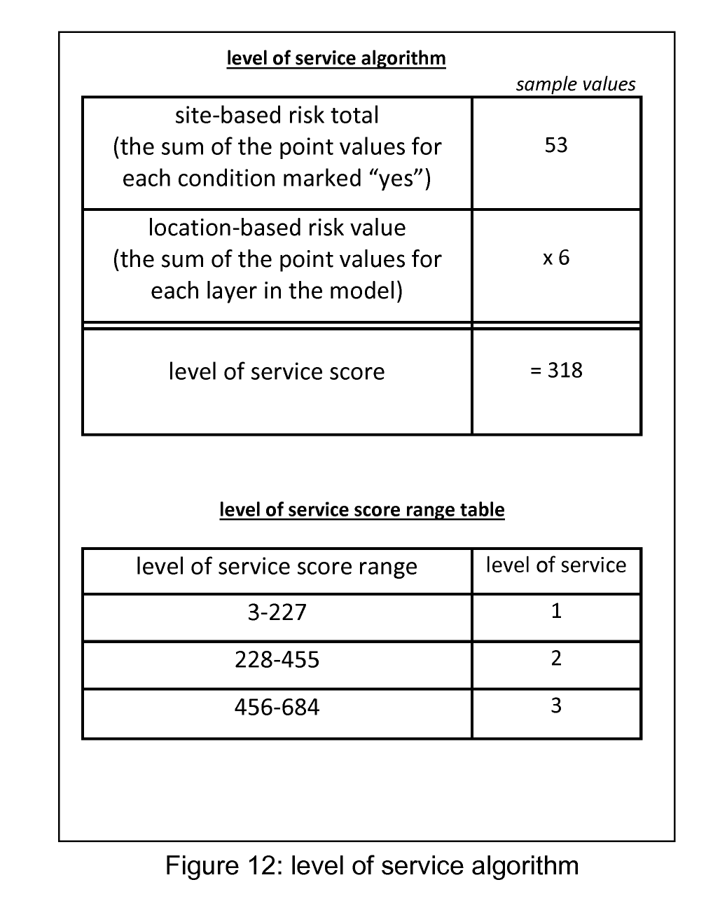

The level of service algorithm (see “C” on FIG. 45) is a calculation that multiplies the site-based risk total by the location-based risk value. The result of this calculation can be used by the insurer/client to define a number of things, including how the wildfire risk assessment provider services the data included in the report (i.e., whether it is autocompleted or requires wildfire risk assessment staff analysis), how underwriting policies are written/priced, and what kind of wildfire response actions are taken. The level of service algorithm is more fully detailed in FIG. 12 below. Level of service thresholds are customized by a givers client's risk tolerance.

The updated wildfire risk algorithm (see “D” on FIG. 45) is used in cases when a given property does not have a site-based risk total (i.e., where no home assessment has been done), and it provides a current sense of a given location's wildfire risk as it changes due to dynamic seasonal factors. This algorithm multiplies a property's location-based risk, value by an updated wildfire risk multiplies to generate an updated wildfire risk value. The updated wildfire risk algorithm is more fully detailed in FIG. 49 below.

The integrated wildfire risk algorithm (see “E” on FIG. 45) is calculated by multiplying the site-based risk total, location-based risk value, and updated wildfire risk multiplier by each other. The result of this calculation provides the most comprehensive view of wildfire risk for a property at a given point in time and can be used by the insurer to drive a wildfire response enrollment effort, wildfire risk assessment provider response actions, etc. The integrated wildfire risk algorithm is more fully detailed in FIG. 50 below.

Referring to FIG. 45 and the above overview of the live algorithms that comprise the present invention, note that algorithms “A” and “D” would not be used together because “D” is an alternative to “A” where no site-based risk total exists for a given property; in other words, the algorithm process flow would be A, B, C and E (with “E” being optional) or B and D (algorithms “C” and “E” cannot be performed without a site-based risk total, which is “A” in this figure).

FIG. 46 is a diagram of the site-based risk algorithm. The site-based risk algorithm produces a total from all conditions with “Yes” values (“wildfire risk is present” for the condition in question). Once data has been submitted to the wildfire risk assessment provider server, the site-based risk total is multiplied by the location-based risk value to generate a level of service score (see FIG. 12).

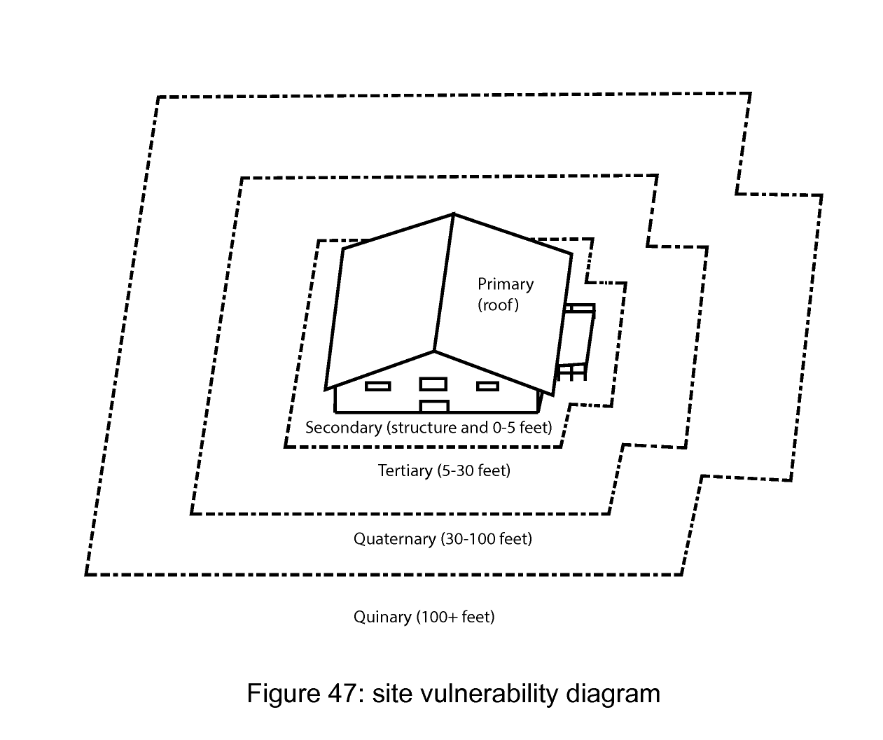

Site vulnerabilities indicated by “Yes” responses to conditions are broken into five categories (see FIG. 47): primary, secondary, tertiary, quaternary, and quinary, as will be mere fully detailed below. In essence, the closer the heat source is to the home, the higher the chance of ignition of the home. As such, the roof of a structure is considered the primary risk zone (44 points) because it is one of its largest features, and as loft/arrangement often creates a near horizontal space on which blowing firebrands can land and collect. The roof condition—if answered “Yes”—has a value designed to force the site-based risk total into the “moderate” range automatically.

If the exterior of urn home is constructed of combustible materials or contains unprotected openings such as vents and windows, direct name impingement radiant heat or entry of firebrands into the home is more likely to result in a home ignition. This area of the home enclosure is the secondary risk zone (four points per condition) due to this potential for direct flame impingement or the entry of firebrands into the interior of the home. This zone includes the structure itself, any combustible attachments to the structure (deck, patio, etc.) and vegetation and combustible materials within five feet of the home.

Vegetation beyond live feet and within 100 feet may have the potential to create sufficient heat flux or loft firebrands onto the home. This risk is reduced as the distance to the home is increased, which explains why fuel is evaluated in two zones: 5-30 feet (tertiary zone; two points per condition) and 30-100 feet (quaternary zone; one point per condition).

If there are substantial bad packets beyond 100 feet from the home, it is possible to generate heat flux in excess of 20 kilowatts per square meter (kW/m²), which likely will not have a significant impact relative to home ignition. The area beyond 100 feet from she home is the quinary zone and carries the same scoring “weight” or influence as conditions noted in the quaternary zone (one point per condition).

The site-based risk total is calculated when the user successfully submits a wildfire risk assessment to the wildfire risk assessment provider server; this site-based risk total can be changed by wildfire risk assessment provider staff after analysis and revision to the wildfire risk assessment (i.e., changing a “Yes” score to “No” or vice versa), or, in some cases, it is not changed because the report output is automated or the site-based, risk. “Yes” conditions are validated by wildfire risk assessment provider staff.

The site-based risk algorithm is as follow:

```
calculateSiteRisk:
  risk = 0
  For each of the conditions,
    risk = risk + getRiskLevel
  site risk = risk
  save
getRiskLevel:
  if the current response is not NO and the current condition number is
1, 3, 4, 6, 7, 9, 10, 15, 18, 19, ro 20 then
    return 1
  else if the current response is not NO and the current condition
number is 8, 12, 13 or 14 then
    return 2
  else if the current response is not NO and the current condition
number is 2, 5 or 11 then
    return 4
  else if the current response is not NO and the current condition
  number is 1 then
    return 44
else
    return 0
```

Notably, scoring can be customized to suit a client's definition of risk and risk tolerance. For example, it can be customized to reflect a client's sense of threat category break and the levels/types of service associated with each category. It can also be revised/updated as wildfire risk definitions are revised/updated (typically yearly) and at the suggestion of the wildfire risk assessment provider.

FIG. 47 is a site vulnerability diagram. As stated in the site-based risk discussion above (relative to FIG. 46), site vulnerability is broken into five categories: primary, secondary, tertiary, quaternary, and quinary. Point values are assigned to each vulnerability category and decrease as the proximity to the structure decreases. The sum total of “Yes” (wildfire risk condition is present) values on or around a structure create the site-based risk total.

FIG. 48 is a diagram of the location-based risk algorithm. This location-based risk value is determined by computing a multitude of wildfire risk factors known to impact a site's potential for wildfire ignition. The location-based risk model is built using the 40 Scott and Burgan fire behavior fuel models. Landscape fuel models include, but are not limited to: elevation, slope, aspect, fuel model, canopy cover, canopy base height, canopy height, and canopy bulk density. Fuel landscape files are loaded into fire behavior analysis and mapping software (e.g., FLAMMAP™ at http://www.firemodels.org/index.php/national-systems/flammap) to produce outputs of predicted flame length and crown fire.

Referring to the present invention, crown fire activity is categorized into four classifications: none (0), surface fire (1), passive (2), or active (3). Flame length is categorized into four classifications: zero (0), four feet or less (1), four to 20 feet (2), and greater than 20 feet (3). The landfire vegetation condition class (VCC) layer is also incorporated into the model, and adds an estimate of the departure of the vegetation structure from “reference” conditions. This layer provides insight into the degree to which the vegetation structure may be uncharacteristically altered and used as a proxy for additional fuel load and continuity. The VCC layer is categorized into four classes: no change/classification (0), low departure (1), moderate departure (2), and high departure (3).

The crown fire activity layer, the flame length layer, and the reclassified VCC layer described above are equally weighted from 0-3, and each layer value is added to create a location-based risk value on a scale of 0-9. The raster math function in ARCGIS™ (http://www.arcgis.com/featuers/) is used to perform this step of the process, and the calculation is as follows:

crown fire (0-3)+flame length (0-3)+VCC (0-3)=location-based risk (0-9).

FIG. 12 is a diagram of the level of service algorithm. The site-based risk total (see FIG. 46) is multiplied by the location-based risk value (see FIG. 48) to yield the level of service score. The result of this calculation is a level of service score that can be used by the insurer client to define a number of things, including how the wildfire risk assessment provider services the data included in the report (i.e., auto-completion of wildfire risk assessment reporting vs. customized wildfire risk report write-up), how underwriting policies are written/priced, and what kind of wildfire response actions are taken by wildfire risk assessment providers. Notably, the client can customize level of service risk, value thresholds to define how the wildfire risk assessment provider processes data.

The resulting level of service score falls into scoring categories—for instance, low, moderate, and high—to determine a course of action to be taken by the wildfire risk assessment provider staff, as predetermined by the client. Report output is returned directly to the users mobile device application in the education use case, and/or to the insurance client office in the underwriting use case.

Typically, properties with the lowest level of service score receive a Level 1 service designation, which auto-generates scoring and recommendation language. Notably, no wildfire risk assessment provider staff risk verification or write-up occurs at this level. Level 2 service includes wildfire risk assessment provider staff analysis of the data that has been collected, including photo and note analysis, map analysis for location-based risk verification, summary write-up of property risk factors and recommendations, and recommendations for “Yes” conditions which—when completed—are likely to reduce wildfire risk on a given property. Level 3 service includes wildfire risk assessment provider staff analysis as outlined by Level 2 service but also goes further to include phone or written communication with wildfire risk assessment provider staff to clarify risk scenario/scoring, advise on mitigation actions needed, and answer questions associated with the report. This is typically reserved for either (a) the most extreme level of service risk values (which could occur in either an underwriting use or an education use case) or (b) level of service risk values that require more information in order for the client to take the appropriate action on the property (typically, an underwriting use case).

The level of service algorithm interaction is called “$this-calculatedLOS”;

if geo risk is 0 or 1 then
return 1
else if geo risk equals 2 and site risk is less than 9
return 1
else if geo risk equals 2
return 2
else if geo risk equals 3 and site risk is less than 27
return 2
else //geo risk equals 3 and site risk is greater than 26
return 3

Notably site-based risk, totals and location-based based value thresholds can be customized to fit client needs.

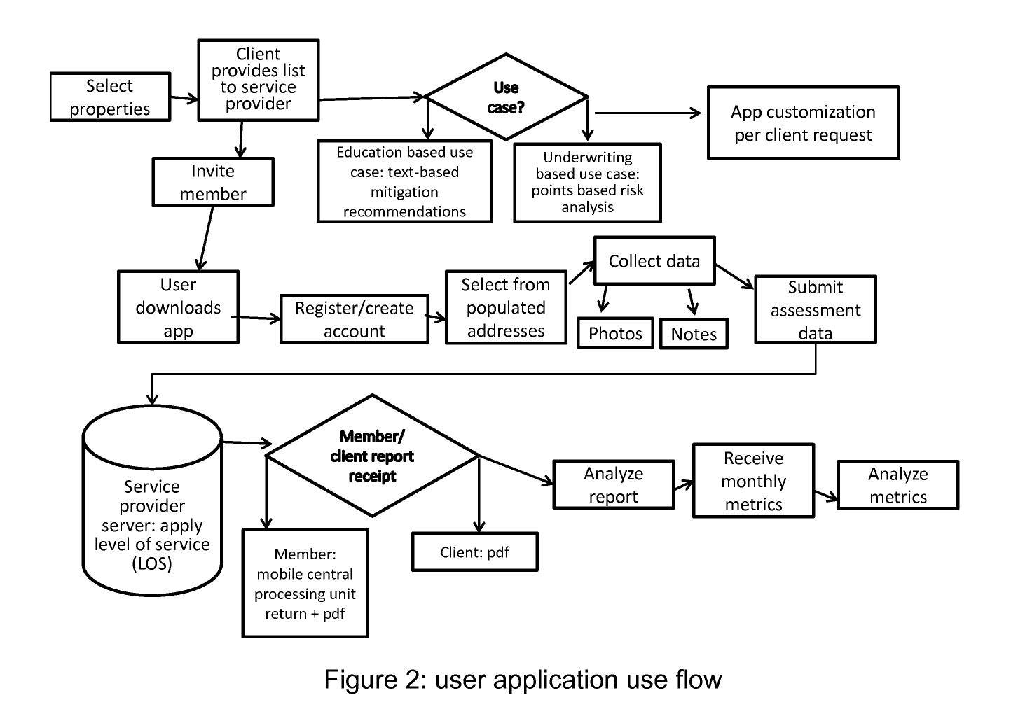

FIG. 2 is a diagram of the wildfire risk assessment application flow from the perspective of the user. First, the user and/or the wildfire risk assessment provider select(s) properties for which assessments need to be completed. Typically, this step occurs before the assessment is to take place. These properties are imported into the wildfire risk assessment provider database, and this action marks the property as “allowed” in the wildfire risk assessment provider database so that once the user successfully registers, the address populates and ties to a pre-generated location-based risk. Underwriting use cases often are not known until the day of the assessment: as such, “add assessment” functionality exists, allowing a new assessment to be added with a user-entered address and/or latitude and longitude.

Regardless of whether the use case is education or underwriting, the mobile device application must be downloaded to the user's mobile device. Then the user must successfully (a) register using a crowded registration code and (b) create an account, widen unlocks the addresses available to the user. Next, the user steps through the data collection process, attaching photos and notes and answering “Yes” and “No” questions as prompted. After all required data has been collected, the user is able to submit the data via a “Submit” button. Submission is considered successful when this data is transferred from the mobile device to the wildfire risk assessment provider server. The successful submission is indicated on the mobile device application in the form of a message and on the web interface in the form of an additional report line that is marked “New.”

At this point, and based on the level of service algorithm, a level of service is applied to the data and a report is generated. This report is either automatically generated or only generated after the data is analyzed and/or manipulated by wildfire risk assessment provider staff. It is then resumed to the mobile device, cheat server, or both. Induction of the report's return appears in the form of a push notification to the mobile device or in an email to the client. A financed version of the report can be reviewed at this time; it is viewable in the form of a series of recommendation screens in the mobile device application, along with a document of the report in the format of a MICROSOFT WORD™ document or ADOBE ACROBAT™.pdf the that the user can download, email or print. In use cases involving an “extreme” wildfire risk, the system provides the user with an option to schedule an appointment to discuss fire assessment results with a wildfire risk assessment provider staff specialist.

Monthly metric data is delivered to the client in the form of an ADOBE ACROBAT™.pdf file, which consolidates all completed report data for a certain date range. Completed report data provided to the client and may include high-level summary metrics, service level summary, level of service summary, condition response totals, and user level summary.

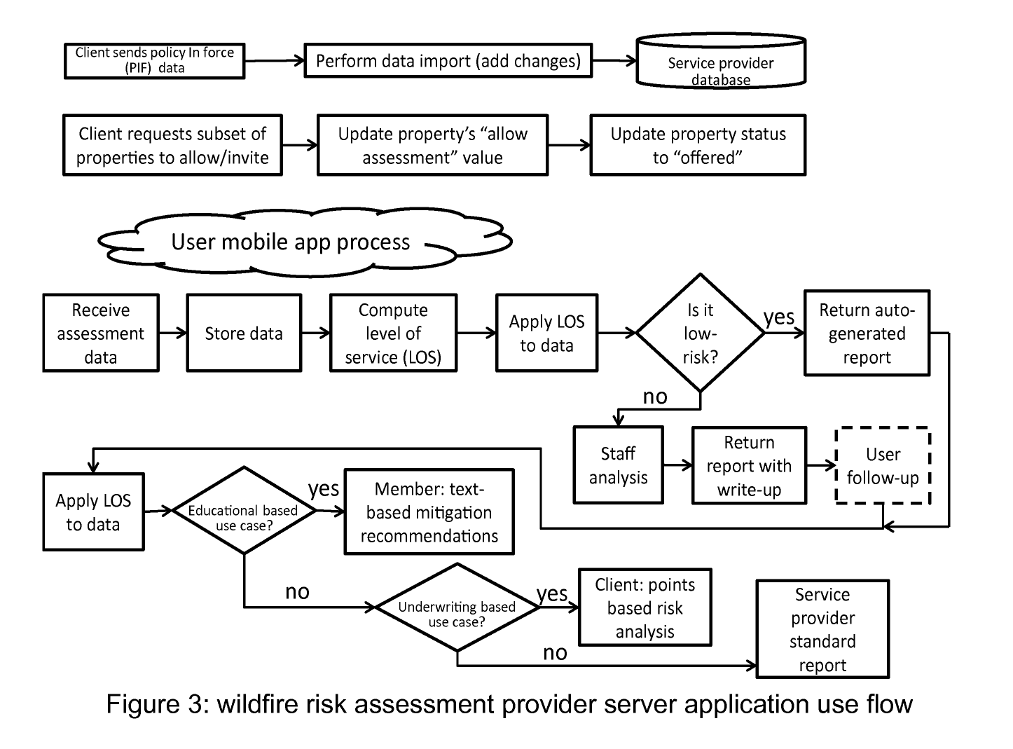

FIG. 3 is a diagram of the wildfire risk assessment provider server application use cases. The wildfire risk assessment provider server receives updated user/policyholder data on a regular schedule, and this data is imported and maintained in the wildfire risk assessment provider database for the client. Included in the updates are arm new user “Adds” and “Changes,” which include any change to existing policyholder data.

On a scheduled cycle, the client (the insurer in a typical case) requests a given subset of policyholder properties be marked as “allowed” to receive an assessment. This requires a status update for all of the “allowed” properties, changing them from “Not Enrolled” to “Offered” and updating their “Assessments Allowed” from “0” to “1”. This change on the wildfire risk assessment provider server allows a given property to populate in the user's mobile device application once registration and account creation have been successfully completed.

Initial mobile device application use requires a wireless data transfer from the user's mobile device to the wildfire risk assessment provider server, which involves submitting a registration code. This registration code is run against all registration codes in the wildfire risk assessment provider server and, assuming a match is made, the code is validated. The user then goes through a similar process for account creation with an attempt to match user last name. Non-matches are reported to the user in the form of an alert notifying the user of the issue. In this case, the user has the opportunity to reattempt the submission. Successful registration and account creation unlocks the version of the mobile device application specific to the user and also makes the property addresses available to him.

The next time the wildfire risk assessment provider server is accessed in the process is when the user submits assessment data. This data is run through the level of service algorithm (see FIG. 12). Typically, data achieving a low level of risk is automatically completed, i.e., it is pushed back to the user/client in the form of a finalized report with pre-created recommendations. Data of a moderate or high level of risk receives staff analysis, which is accomplished using the web interface that allows wildfire risk assessment provider staff to review any photo and/or note data attached to a given risk condition. Additionally, the property location, receives a more thorough manual analysis (including map software overhead analysis, fire history research, updated climate information, etc.) to determine how wildfire activity is likely to occur in that area. Wildfire risk assessment provider staff can validate or invalidate user wildfire risk assessment condition-by-condition, which can impact the site-risk total for that property's risk, summary write-up, and level of service functionality. Once completed, this customized analysis is returned to the user's mobile device in the form of an interactive report containing “Summary” and/or “Recommendation” menu options with information screens, and/or the client as MICROSOFT WORD™ document or ADOBE ACROBAT™.pdf file.

Report output generated at the wildfire risk assessment provider office varies by client desire and use case. For instance, education use case policyholders will receive a less technical write-up that is a call to action or serves to create general awareness of risk issues. Underwriting use cases receive a more technical, points-based analysis that could help inform insurance policy decisions for a given property,

Both the raw data and final report are archived in the wildfire risk assessment provider server and can be called up at any time using web interface search functionality. Additionally, the data can be used to generate sort-by-date reporting for the client, most typically in the form of a monthly report, that consolidates all user activity that occurred.

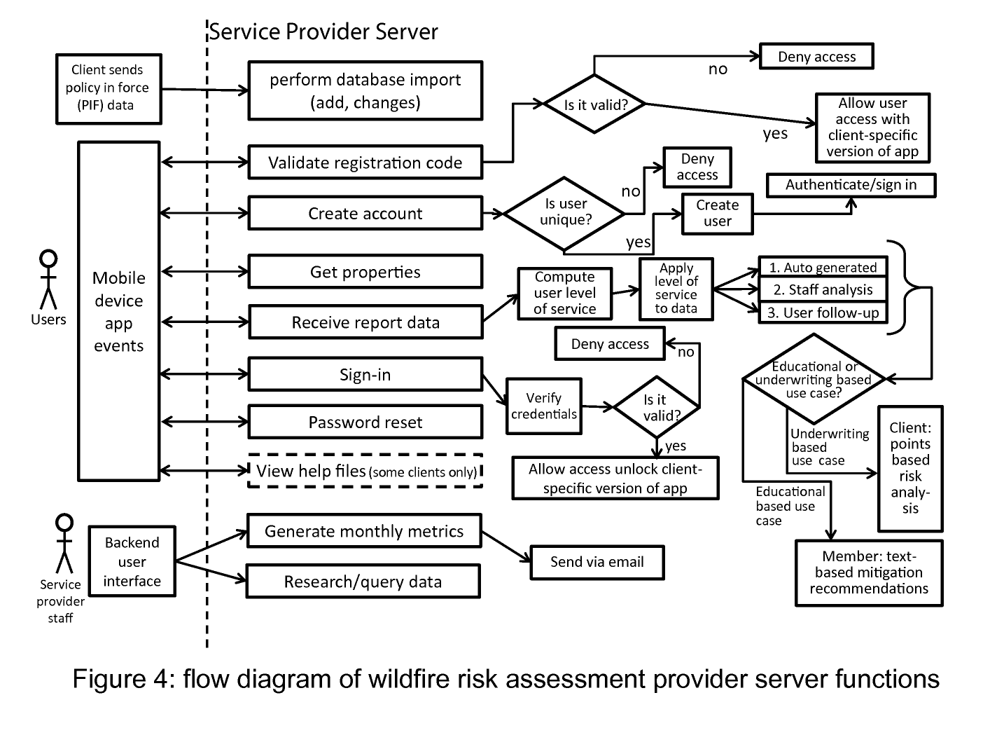

FIG. 4 is a flow diagram of the wildfire risk assessment provider server functions. The communication between the users mobile device application and wildfire risk assessment provider server occurs via an application programming interface (API), which is protected by OAuth (an open standard for authentication). Assuming the user has already downloaded the application, and any predetermined policyholder access to the mobile device application has been programmatically updated in the wildfire risk assessment provider server, the following server functions are available:
1) Data import. When the client sends policy in force (PIF) data to the wildfire risk assessment provider server, an import function will be run to import the data into the database.
2) Registration code validation. This is used to make sure the provided registration code exists in the database and is valid.
3) Create account. The system checks to make sure the provided email address is not already in the system, and if it is, a message is returned indicating the error. As an additional security check, the provided last name must match the policyholder associated to the registration code entered previously. If they do not match, an error message is returned. Otherwise, the account is created, and the user is authenticated successfully.
4) Get properties available for assessment. If no properties are available, a message is returned so indicating. Otherwise, the property data is returned.
5) Authentication/sign In. The wildfire risk assessment provided user name and password are validated. If these are not valid, an error message indicating the problem is returned. Otherwise, the user is successfully authenticated in the system. In both the create account and sign in functions, the wildfire risk assessment server unlocks the appropriate version of the mobile device application based on the user type. Information regarding the version of the mobile device application is returned to the mobile device application at this point. For example, an underwriting user would receive a different set of assessment questions than an education user.
6) Receive submitted assessment data. The wildfire task assessment provider server applies level of service rules to the submitted assessment data, autocompleting a low risk level report and allowing moderate and high risk level data to be analyzed and completed by wildfire risk assessment provider staff. Once the report is ready to be returned, a push notification is sent it to the mobile device.
7) Schedule an appointment interface. If the user is returned a report of high risk, an option will be presented within the mobile device application to schedule an appointment to discuss the score with a fire specialist over the phone. The wildfire risk assessment server provides a mobile-friendly web interface to schedule a date and time using a standard date/time picker. The selected date and time are saved in the database, allowing wildfire risk assessment provider stair to review and call the policyholders as necessary.
8) Password reset. The wildfire risk, assessment provider server ensures that the current password is valid and that the two password values match. If they do, the user's password, is updated.
9) Metrics. The wildfire risk assessment servers web interface allows summary metrics to be generated for a given time frame. Most typically, this time frame is one month.
10) Research queries. The wildfire risk assessment provider server archives all contemplated report data, which can be accessed using basic search/sort functionality via the web interface.
11) Reference content. For certain user types, the mobile device may request help files, videos, or other content for reference/help or welcome/introduction materials from the wildfire risk assessment provider server.

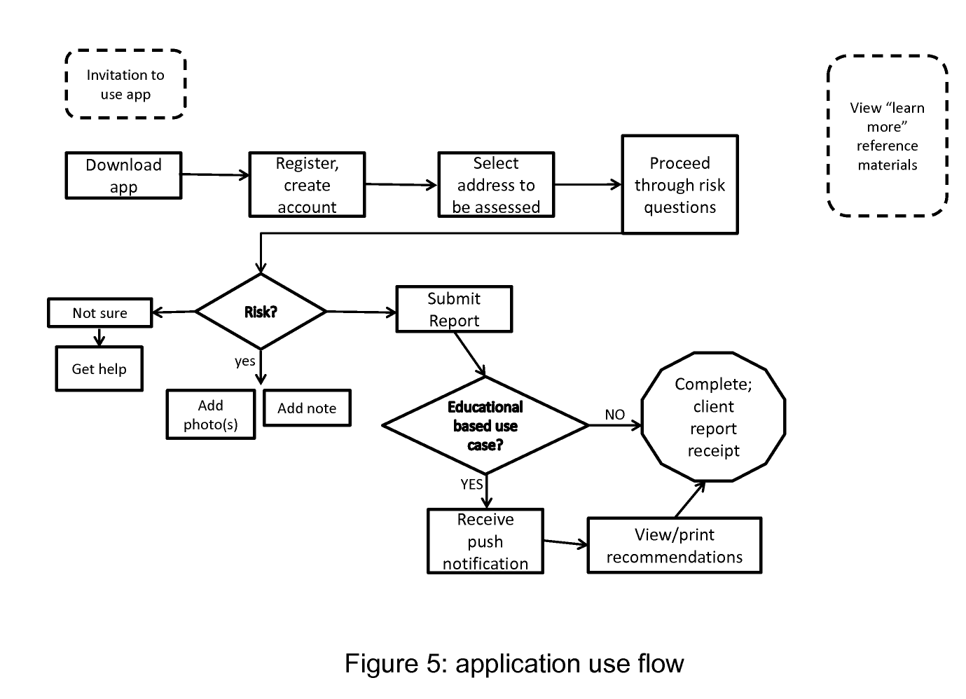

FIG. 5 is a diagram of the mobile device application use flow from the perspective of a user. In most use cases, the user will receive an invitation to use the mobile device application. This comes in the form of an email or request from the client or wildfire risk assessment provider office. The invitation will include all needed information to unlock the application, including the registration code.

Initial use of the mobile device application requires the user to navigate to either the GOOGLE PLAY™ or APPLE™ mobile device application store and download and install the mobile device application to his mobile device. Once the mobile device application is open on the user's device, he is immediately prompted to enter a registration code. This submission is sent to the wildfire risk assessment provider office, verified, and a success message is returned to the user, thus allowing him to proceed.

The user creates an account by entering his first name, last name, email address, and desired password. If successful, the account will be created, and the user will be authenticated. Otherwise, an error message will be displayed. Once the user has logged in with a verified registration and account, he is able to select a property for which he has been pre-approved to begin an assessment. In underwriting use cases, underwriting staff do not necessarily have prepopulated addresses to select from. As such, they are able to add a property when they reach the address and then proceed through the wildfire risk assessment application.

Next, the user walks through all data collection steps, answering “Yes,” “No” or “Not Sure” to questions and attaching photos or notes to risk conditions as prompted. The user is able to view help material that comes in the term of wildfire risk descriptions, photos, and videos to help him understand a given question and how best to answer it. Once the user has completed all data collection requirements, he is able to submit his data to the wildfire risk assessment provider server for processing. A completed report is returned to the user's mobile device or the client's server, and push notification is sent to the user's device informing him that the report is ready. In an underwriting use case, this push does not go back to the mobile device; instead, a notification is sent to the client server in the form of an email. The user/client can view the report in the term of a MICROSOFT WORD™ document or ADOBE ACROBAT™.pdf file.

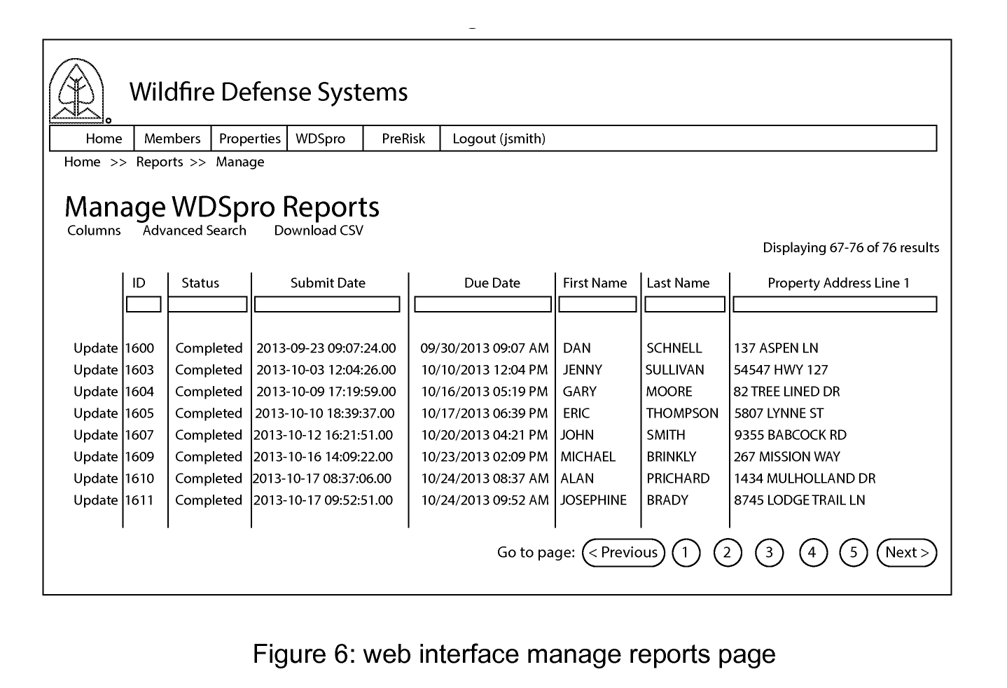

FIGS. 6-8 are examples of the web interface used by wildfire risk assessment provider staff to analyze data collected in the field. When assessment data, is submitted to the wildfire risk assessment provider servers, it is put into an interface under the header “Manage Reports” (see FIG. 6) by which indicates the data status, relevant user information, due dates, etc. Reports are displayed in nearest to due date order as a default, although this view can be customized. Clicking the update link on the left side of the screen allows the user to get into the detail of the specific data collected for a given property in the “Update Report” screen.

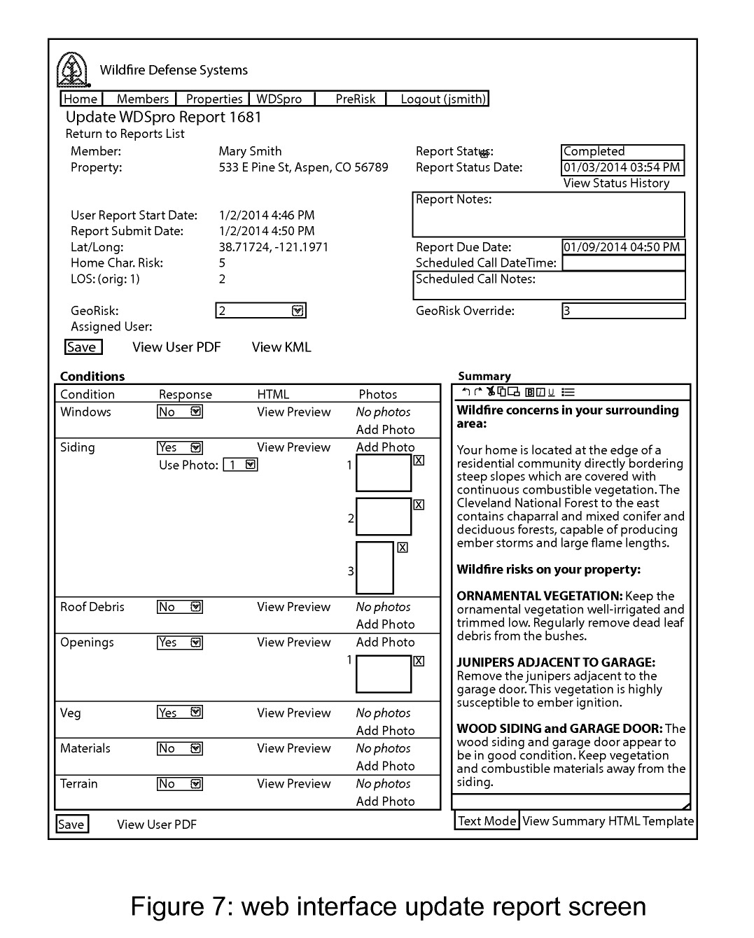

The “Update Report” screen (see FIG. 7) consolidates basic report information, including user detail, report submission and due date detail, status, and identification of the wildfire risk assessment provider staff member who has worked on the report. A conditions section breaks the conditions out individually, associating any notes and photos that have been submitted for the condition. Using drop-down menus, wildfire risk assessment provider staff are able to validate or invalidate user responses. They are also able to remove and add photos to a condition and select which photo best represents the condition and should appear in the final report. A summary section allows wildfire risk assessment provider staff to write detailed mitigation recommendations for the user describing area threats based on location.

Report status works as follows: (a) reports are listed as “New” when they are first received at the wildfire risk assessment provider server, indicating that no wildfire risk assessment provider staff has begun work on the report; (b) an “FRA” status indicates that a fire risk analyst is analyzing the report photos, condition risk assessments, and writing a summary; (c) an “Editor” status indicates that an editor is copy-editing the text to ensure grammar and readability; and (d) a “Completed” status as indicates the report is complete and triggers the completed report to be sent to the user/client.

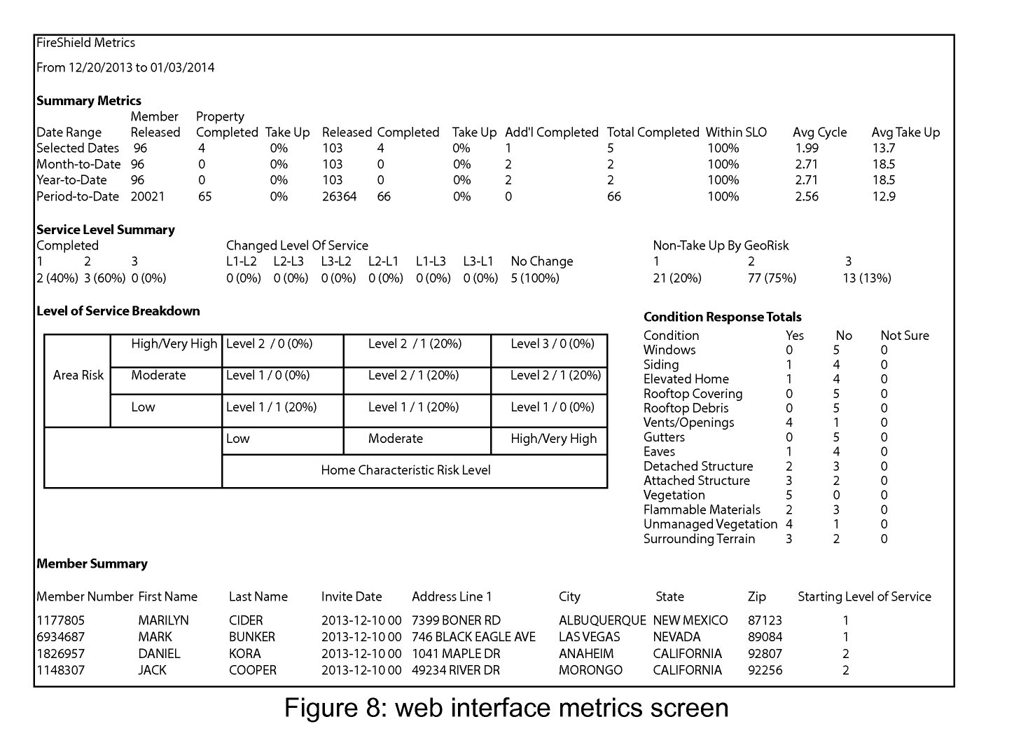

The metrics page (see FIG. 8) displays summary metric data based on date sort. Wildfire risk assessment provider staff are able to enter start and end dates to see basic metric data for all assessments completed within that time range, including summary metric totals, service level summary, level of service breakdown, condition response totals, and policyholder summary. A “Print Metrics” hyperlink allows wildfire risk assessment provider staff to create an ADOBE ACROBAT™.pdf report that can be sent to the client.

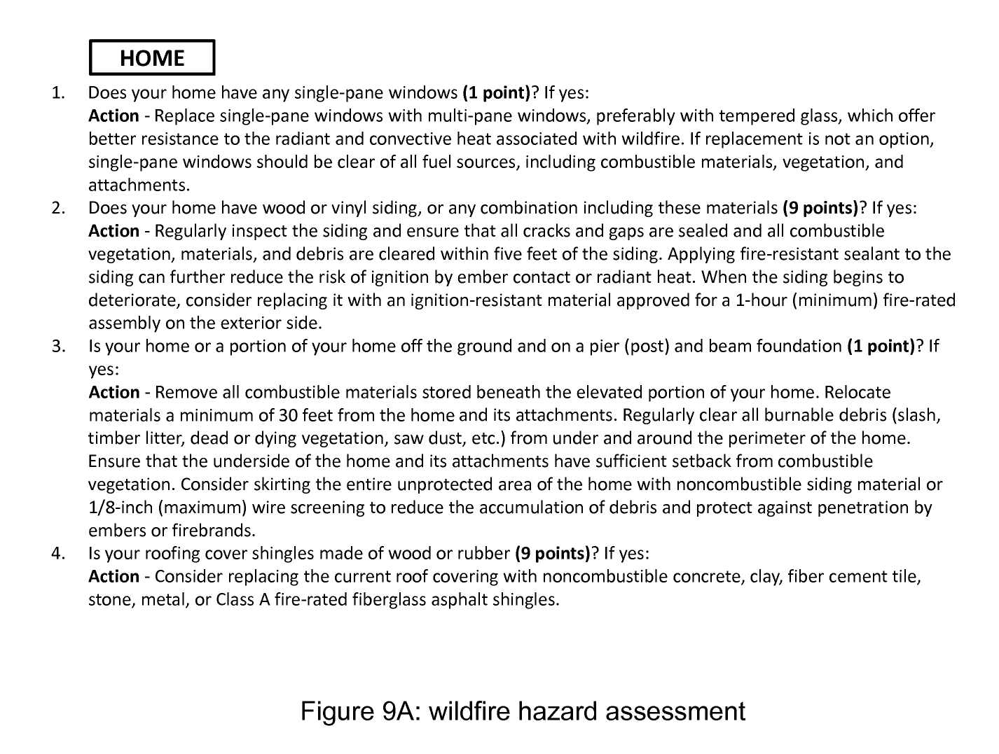

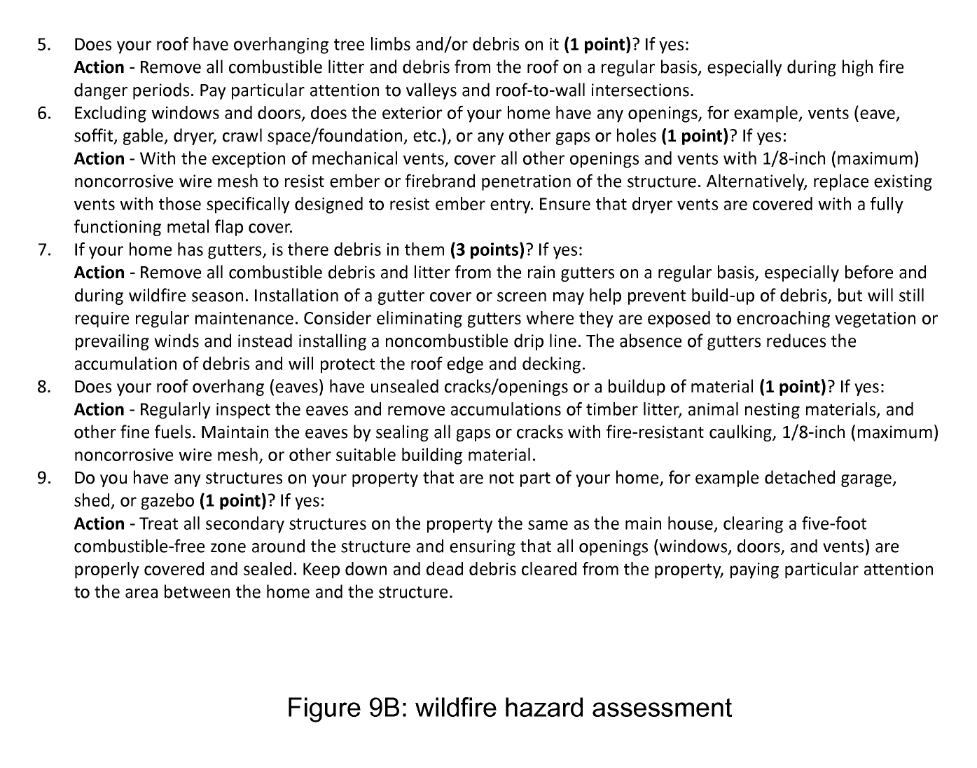

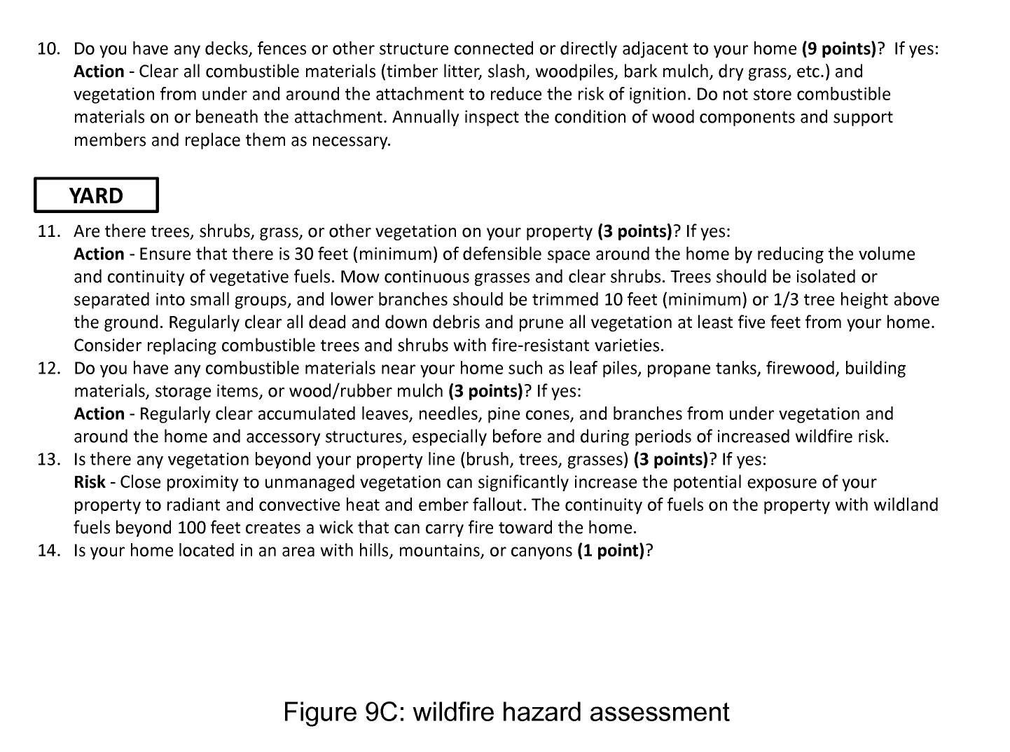

FIGS. 9A-9C provide art example of the wildfire hazard assessment dialogue that is generated using the mobile device application. Included in this dialogue are (a) wildfire risk condition questions, and (b) actions that are recommended to users who answer “Yes” to a given risk condition. If a given wildfire risk condition (for instance, venting has openings larger the ⅛) is answered “Yes,” points assigned to the condition are added to the accruing site-based risk total, and a total value of the home condition risk is generated once all conditions are completed. This site-based risk total interacts with the location-based risk value to create a level of service (see FIG. 12) to be completed by wildfire risk assessment provider staff.

This wildfire risk assessment text is dynamic and can be changed to suit the client's evolving needs or updated by the wildfire risk assessment provider. Verbiage and tone can be tailored to suit various user types, including less formal policyholder education use case outputs or more formal/technical uses for insurance underwriting use cases. The level of detail in the auto-generated recommendations can be modified to suit user type and client as well. For instance, certain clients may prefer to provide an all-encompassing set of recommendations to fit a broad spectrum of risks in cases where no wildfire risk assessment provider staff analysis is going to occur. On the other hand, clients that always receive a summary write-up from the wildfire risk assessment provider office may want this pre-created text to be more minimal or not appear at all.

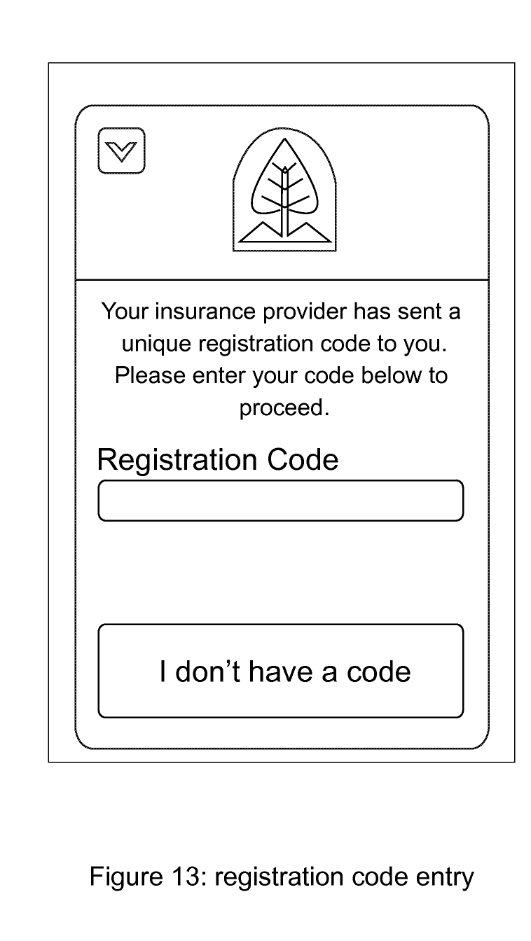

FIG. 13 is a screenshot of the registration code entry screen. This screen is used for three reasons: first, to authenticate users who have been preapproved (that is, they exist in the wildfire risk assessment provider server database and have an assessment or assessments that have been approved to populate upon successful registration code entry); second, to unlock the variant of the mobile device application specific to that user/client type; and third, to act as the first of two security measures to disallow uninvited users, including hackers, from accessing the application, which could grant them access to sensitive client and/or user data.

Touching the registration code entry box opens an insert text dialogue, where users are able to enter the code they were provided. Codes are combinations of letters and numbers, and text case defaults to all-caps to reduce text entry errors. Upon registration code entry completion, the user clicks “Done,” which makes a call to the wildfire risk assessment provider server for validation. If the code is validated at the server, an “Approved” message is displayed on the mobile device. Clicking “Continue” moves the user into the mobile device application, where he can begin the wildfire assessment data collection process. Codes that are invalidated at the wildfire risk assessment provider server produce a return “Invalid” message on the mobile device application interface, and the user is able to “Try Again.”

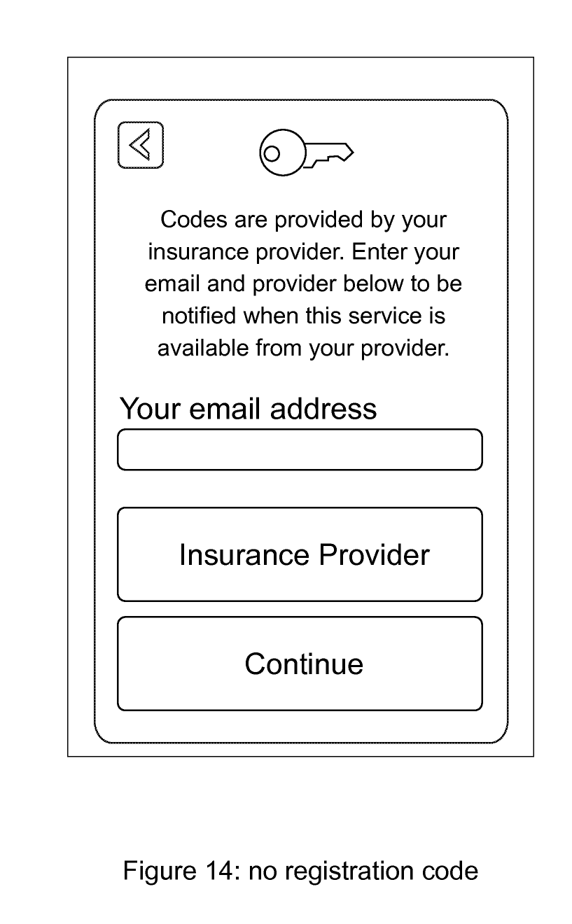

Until a user successfully enters a registration code, he can go no further in the mobile device application; however, clicking “I Don't Have a Code” (see FIG. 14) allows a user to submit an email address and identify his insurer to the wildfire risk assessment provider server in an attempt to be provided with a code. Provided email addresses are researched using the office database and if they tie to a user, the client is notified of this request.

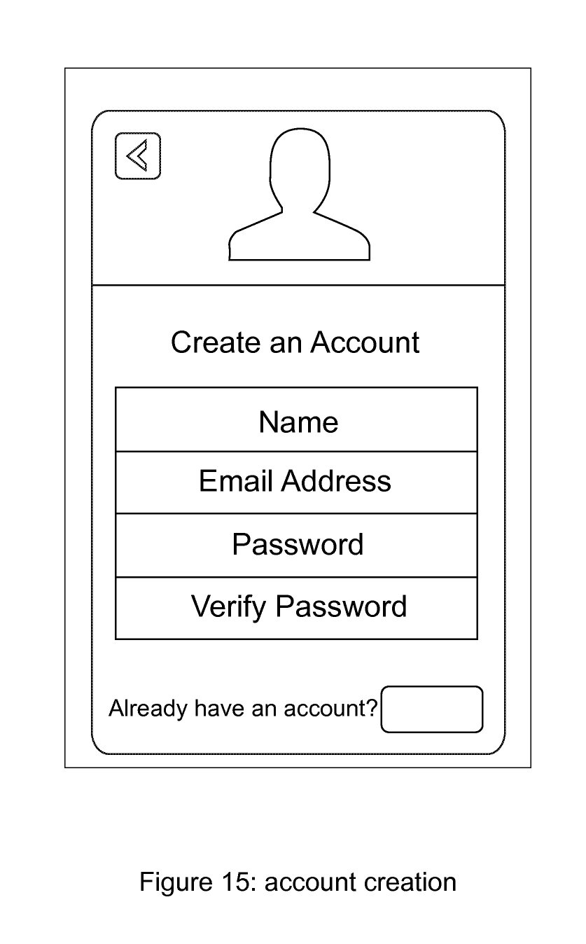

FIG. 15 is a screenshot of the account creation screen. This screen has two primary purposes: first, to serve as the second security checkpoint, requiring users to successfully enter the last name associated with the pre-supplied registration code; and second, to act as the user's key back into the mobile device application if he logs off or wants to view his account on a different device.

Touching the name field brings up a text dialogue, allowing the user to enter a first name, last name, email address, password, and password verification. The email address field requires a recognized top-level domain extension (.com, .net, .org, etc.) in order for the user to be able to successfully fulfill requirements for the field. If the password is not successfully reproduced in the “Verify Password” box, an error message is produced informing the user of the mismatch. Text case defaults to all-caps to reduce the likelihood of text entry problems. Clicking “Done” submits the data to the wildfire risk assessment provider server, which validates the last name against the registration code associated with the account. A user who successfully create a match net an “Account Created” message return from the wildfire risk assessment provider server, and clicking “Continue” allows him to gain access into the inner working of the application; more specifically, this takes the user to the “Select Property” screen, which shows him locations he has been preapproved to assess. A user whose last name does not match the associated registration code gets an error message; in this case, the user has an opportunity to retry the account creation process.

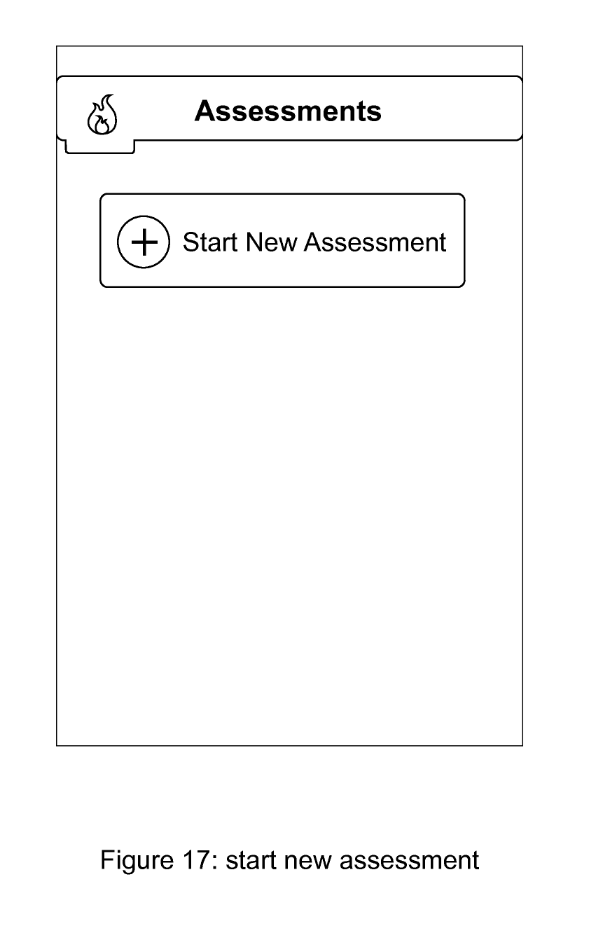

FIG. 17 is a screenshot of the property selection screen. This screen enables a user to select the properly or properties for which he has been approved to complete assessments. This screen is accessed in a couple of different ways: it is brought up immediately following the user's successful account creation and approval message, and it comes up any time the user clicks the “Start New Assessment” button (see FIG. 17). Property population logic is as follows: addresses that have (a) not been started and (b) are marked at the wildfire risk assessment provider server as “allowed” (specifically, they have a number allowed greater than zero) automatically appear. The same address appears only once, regardless of the number of assessments that have been allowed. The addresses continues to reappear following a user pressing “Start New Assessment” until the user completes a given question for that property, at which time he is moved to the initial “Assessments” page; here, the users level of completion is made clear by a notation that appears above the “Start New Assessment” button and under the label of “In Progress.” If a user clicks “Start New Assessment” but does not have a new property allowed, a “Not Allowed” error message is returned, explaining that them are no new assessments available.

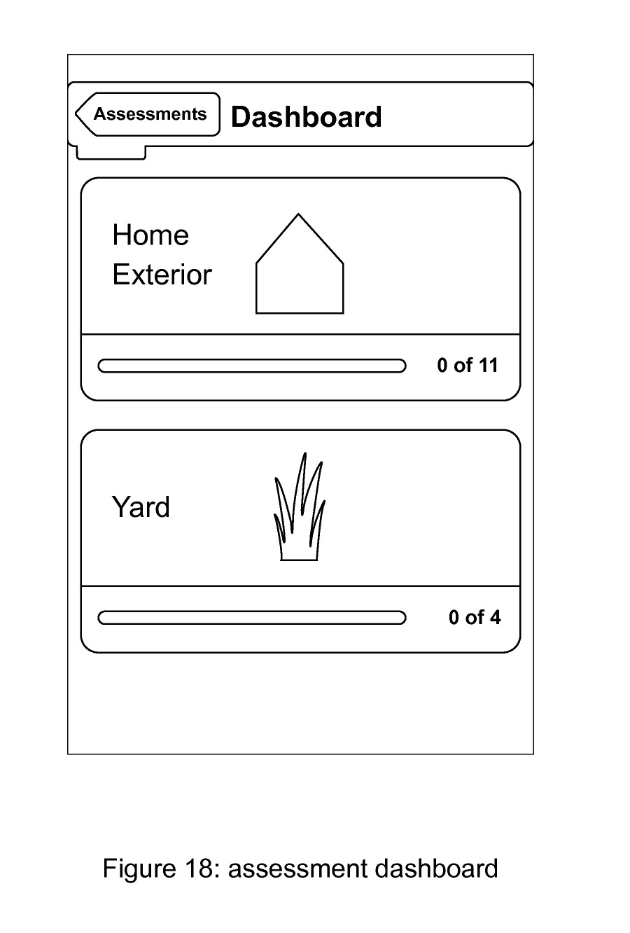

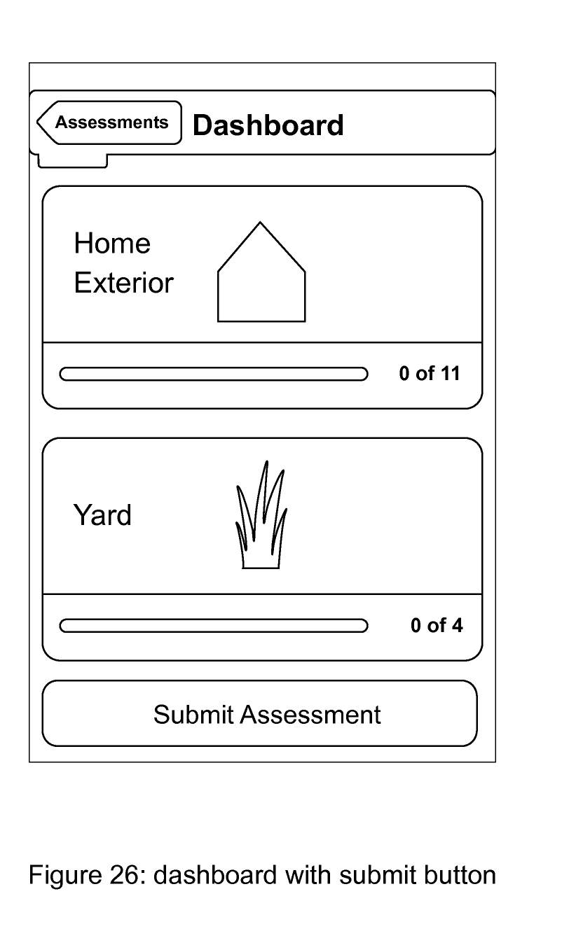

FIG. 18 is the assessment dashboard screen, which is designed to break an assessment into logical data collection subsets. A progress bar for each of the data collection subsets is included in display nearness to completion for the user. Once all questions are successfully completed, the user is returned from the risk questions to the dashboard, where a “Submit Assessment” button appears for the first time (see FIG. 26). Clicking “Submit Assessment” sends the assessment data to the wildfire risk assessment provider server.

When selecting a data collection subset that is partially completed (i.e. “2 of 14” shows in the progress bar), users are taken to the first unanswered question in the data collection subset. For instance, if a user completed questions one, two, and four in a given subset, returned to the dashboard, and then returned to the same subset, the user would be taken to question three. Returning to a given subset that is completed takes the user to the first question, allowing the user to review and change any questions in the subset.

The dashboard example shown in FIG. 18 is geared toward a more traditional wildfire hazard assessment checklist and broken up into two sections: home exterior and yard. The home exterior option allows users to proceed through questions specific to materials that make up their home/primary structure. Risk items include, but are not limited to, windows, siding, elevated components, roof material, debris on the roof, openings in the wall/attic, gutters, eaves, detached structures, and attached structures. The yard data collection items include, but are not limited to, vegetation on toe property, combustible materials on the property including secondary structure like decks and fences, unmanaged vegetation outside of the property, and topography conditions around the property.

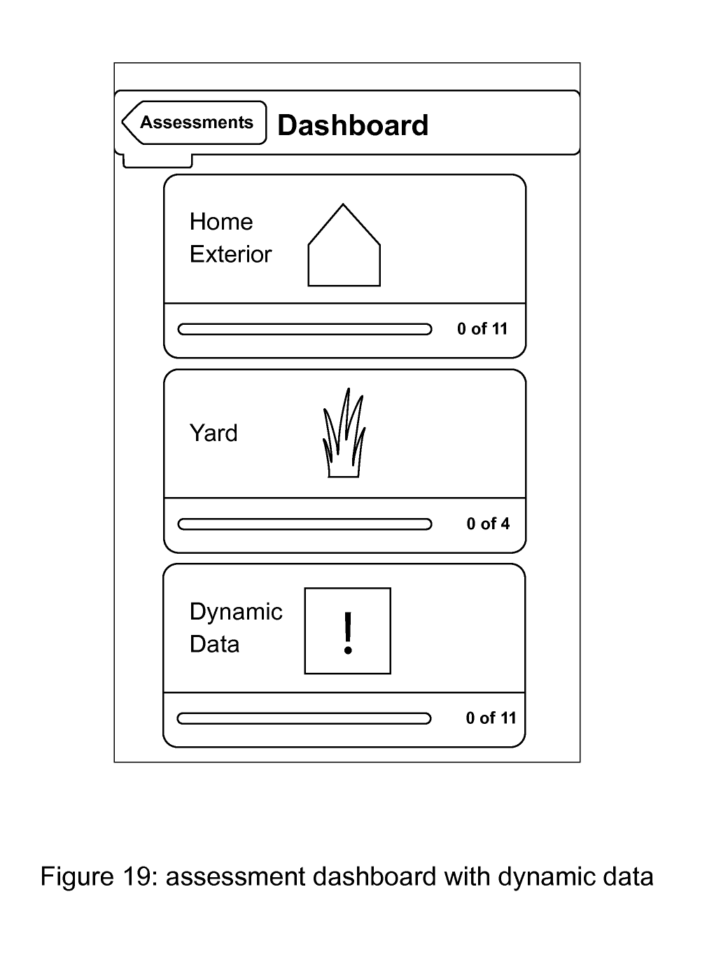

The dashboard example shown in FIG. 19 displays a dynamic data collection set, including both the home exterior and yard subsets, and further including a variety of dynamic data collection types. These data collection sets could include questions specific to commercial properties, multiple structure properties, risk items not specific to wildfire, etc. It should be noted that all questions—regardless of data collection desired—are dynamic, which is in say their number, verbiage and data collection rules can be changed to suit whatever data collection scenario is desired.

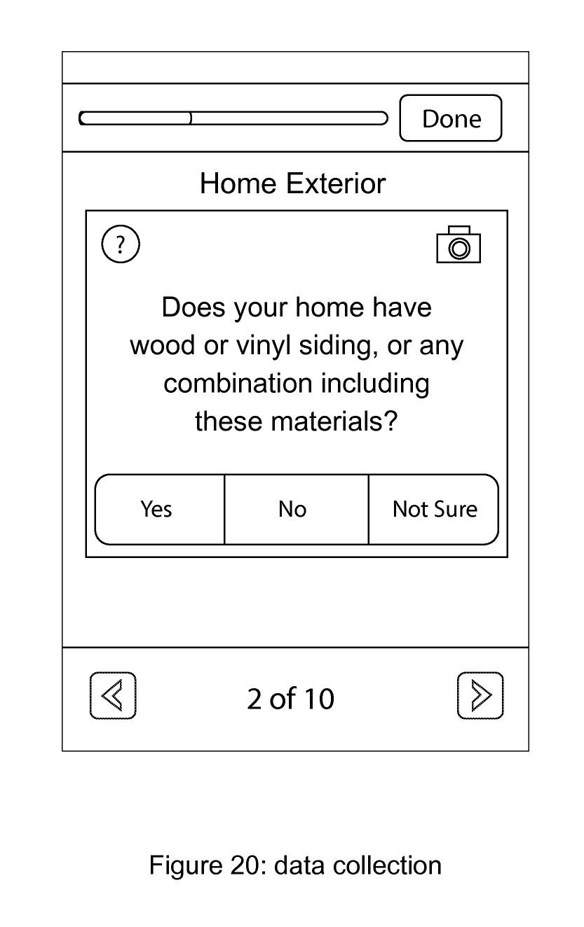

FIG. 20 is a data collection screen, which allows users to gather data of varying types and to varying degrees of depth. In a typical scenario, text instruction directs the data collection, often coming in the form of a question that requires a “Yes” or “No” answer. Depending on the user case, “Not sure” and “Help” selection buttons can be accessed to further describe what data is desired; this information may come in the form of text detail and photo/video example support.

Text instruction is customizable based on the client/client type, and verbiage may be as technical or non-technical as is desired. Additional questions can be added to suit client-specific scenarios, and data collection cues can be made in the form or questions or directives.

Data collection requirements are similarly customizable. In education use cases, clients may want to leave the mobile device application more open, allowing users to answer “Not Sure” and not forcing text or photo evidence to support any of the answers users select. In underwriting use cases, forced data collection rules ensure that data risk collection requirements for every risk scenario are met. The text entry feature gives the user the opportunity to describe the scenario; this feature can be forced, optional, or nonexistent. Drop-down menu functionality can be used to suit cases where given subset options exist (for instance, roofing material type). A minimum number of photos may be forced before a given data collection scenario is marked complete (for instance, a “Yes” answer could force the collection of two photos that support this “Yes” answer).

Navigating between data, collection screens varies based on user type (for example, an education use case allows a user to select “Not Sure” as an option that completes the question, whereas an underwriter use case does not induce “Not Sure,” and requires the user to answer “Yes” or “No” and provide a requisite number of photos and a note). Regardless of the type of use case a “Back,” “Forward,” and “Done” button are always present. “Back” returns the user to the previous data collection scenario, and “Forward” moves the user to the next data collection scenario. In typical cases and regardless of user type, these buttons are always active. Pressing “Done” returns the user to the assessment dashboard screen. When a user re-selects that subset of data collection from the assessment dashboard screen, he is taken to the first unanswered question in the subset.

If a question has not been completed, the “Yes” and “No” button selections are colored gray. Completing a question to satisfaction turns the applicable button blue. Partial completion—for example, when a user answers the question but does not add the required photo(s)—turns the button an intermediate color (e.g., green).

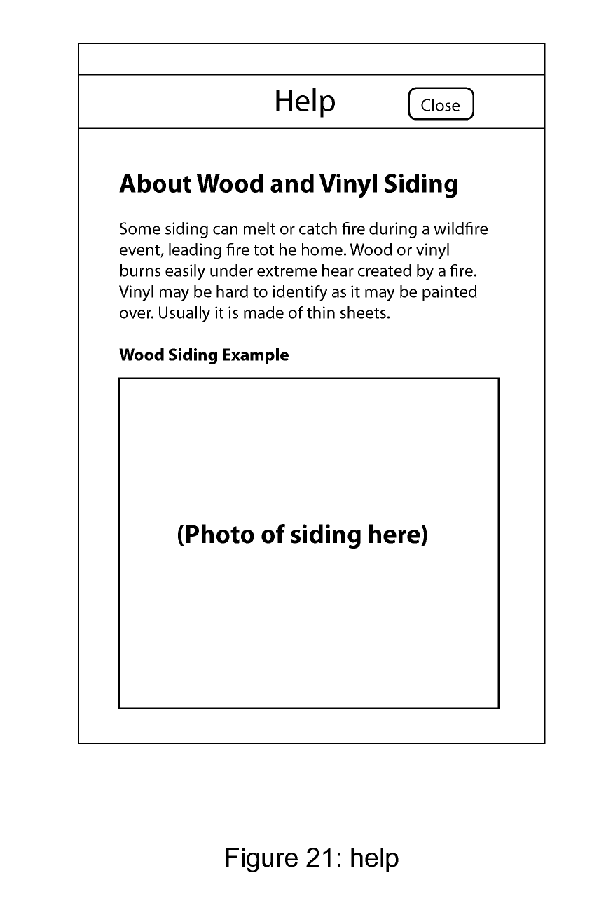

FIG. 21 is an example of a help screen. This screen appears when a user presses the “Help” or “Not Sure” icon. These options ace always active in education use cases and may not exist in art underwriting scenario (underwriting use cases) because users in the latter group are well-versed on the demands of the data collection process. “Help” type information is intended to increase the user's ability to effectively satisfy data collection requirements and may include video, photo, and text-based support to help the user understand what is being requested.

Education use case users are able to select “Not Sure” as an option, which effectively acts as a “No” response: however, if a user does collect information that can be analyzed in association with this “Not Sure” condition, this information can be used to support a “Yes” or “No” decision by wildfire risk assessment provider staff.

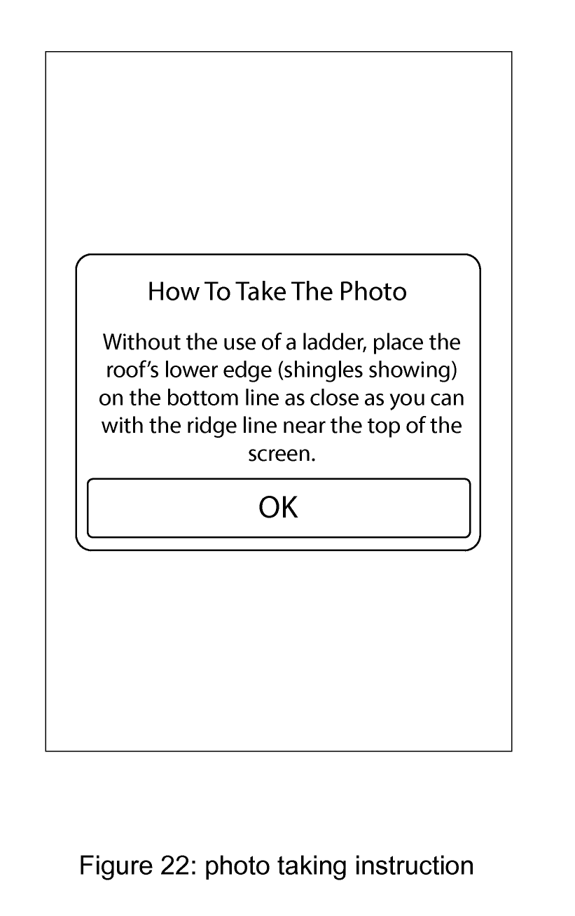

FIGS. 22-25 are examples of the various photo collection screens. These screens allow users to attach photos to a given data collection scenario. The initial photo taking instruction screen (see FIG. 22) includes simple instruction test that explains how to take the photo, and the user clicks “OK” to proceed. This screen is best suited to the education use case because users of this kind are likely to be interacting with the photo request for the first time and may need this extra information; underwriting users would likely not see this screen because they will encounter the photo capture scenario repeatedly, thus tendering the instruction of little value.

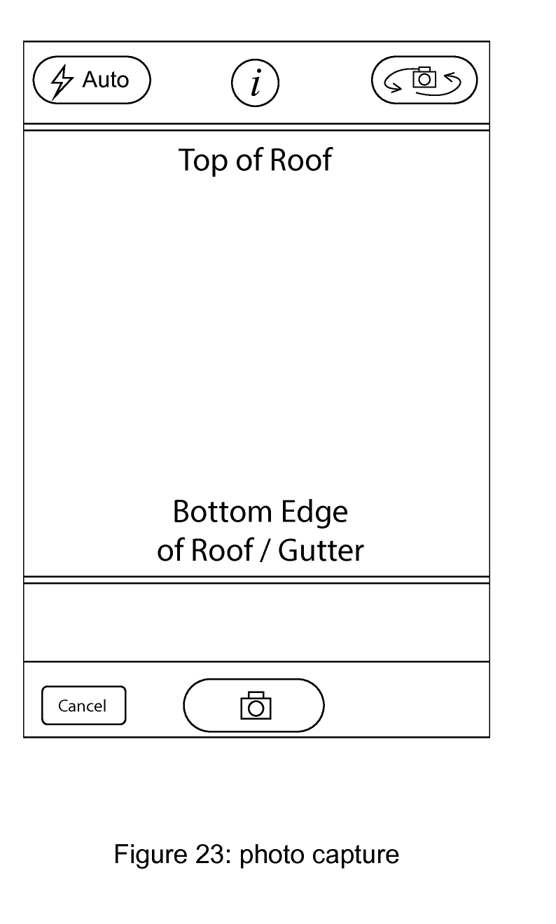

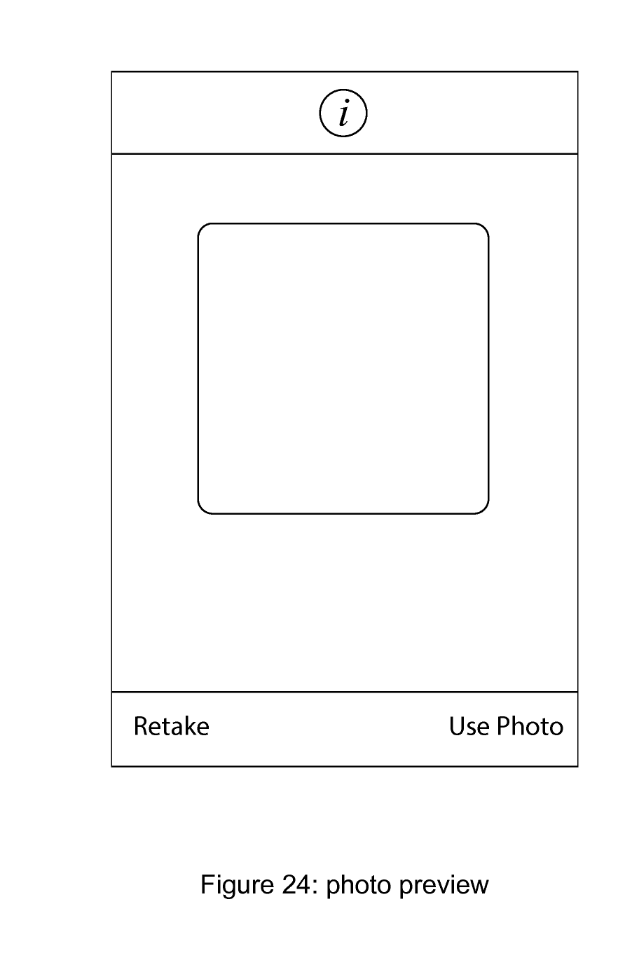

Once the user clicks “OK,” he is taken to the photo capture screen (see FIG. 23). This screen has a camera icon at the bottom that is active; pressing it triggers the photo capture mechanism. Photo guidelines mat helpful text may appear to help the user hone in on the desired level of detail, perspective, zoom, etc. Once the photo has been taken, it appears in the photo preview screen (see FIG. 24), where users are able to “Retake” the photo if they are not satisfied, or select “Use” to indicate that they want to keep it.

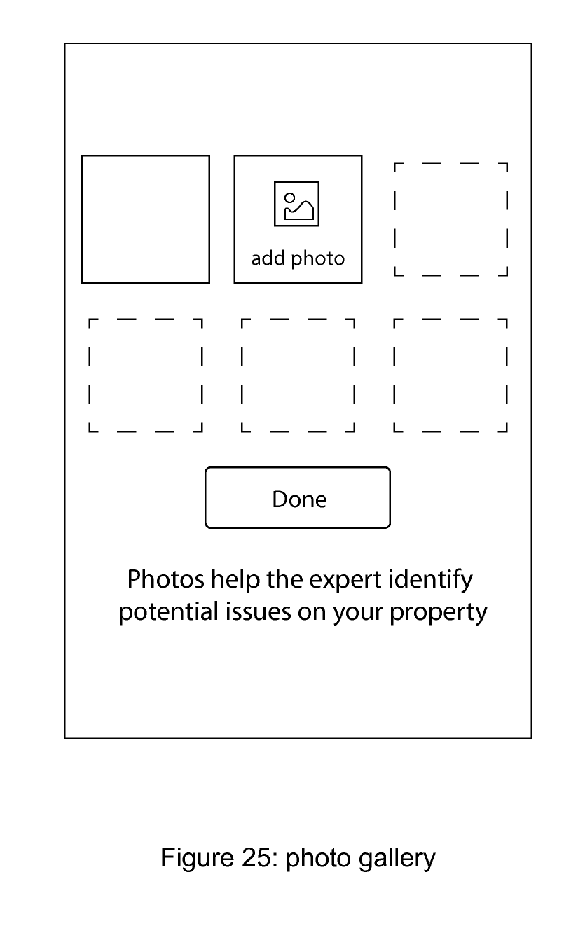

Once a photo has been selected to be used, the user as taken to the photo gallery screen (see FIG. 25), where all photos that are associated with the particular data collection scenario appear. The most recent photo takes up the first available space in the gallery, and remaining collection opportunities show as empty to indicate that additional photos can be taken. The first of these shows an “add photo” icon; pressing this icon takes the user back to the photo capture screen. A user can review a photo he has taken by touching it. This action takes him back to the photo preview screen, where he is able to view the photo in its full size; pressing “Back” takes the user back to the photo gallery screen. The user can click “Done” at any point on the photo gallery screen, which moves him back to the data collection screen (thus removing him from the photo capture cycle of screens).

The data collection screen (see FIG. 20) shows all photos the user wants to “use” for the condition under a paperclip and thumbnail image of a photo clipped to it. Additionally, a user can click the camera icon at the top of any of the data collection screens in order to move info the photo taking dialogue.

In a preferred embodiment of the application, photo taking requirements are assigned based on client needs and may be uniquely suited to the demands of a given condition. For example, the photo taking screens may (a) result automatically (regardless of how a question is answered), (b) not result automatically but be accessible by using the camera button, or (c) not result at all. Photos may be required in every case, never be required (and always be optional), or be required only when a user selects “Yes” to indicate a given risk is associated with a condition. Additionally, the number of photos required may be specified based on how important photo examples are to analyzing risks associated with a given condition.

For underwriting use cases, it is likely that photo taking will be repaired for all or most conditions, and additional photos depicting all sides of the structure and all directions away from the structure will always be required. Such rules ensure that sufficient data is collected to support decisions about risk and that the potential for missing data is minimized.

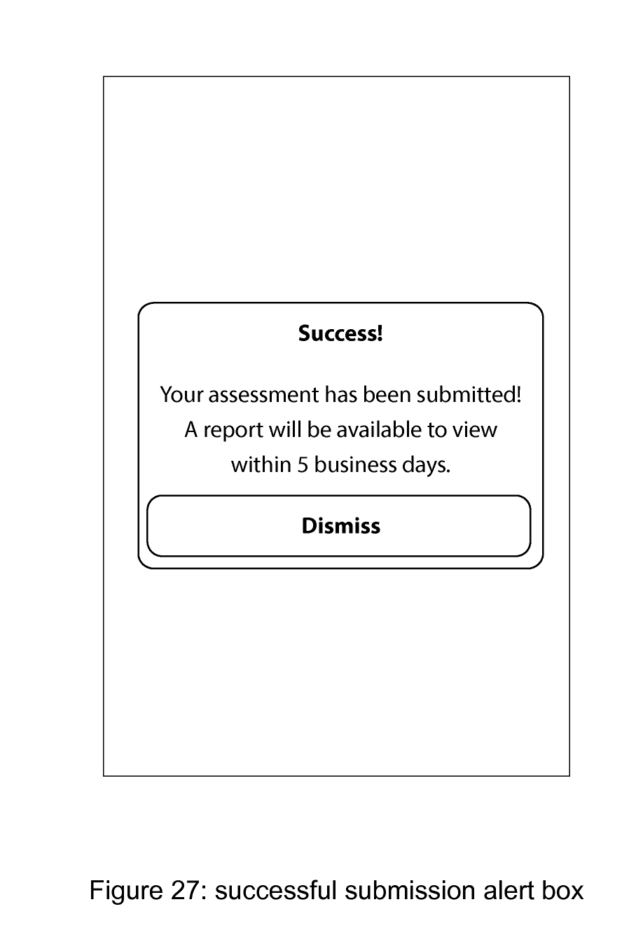

FIGS. 26 and 27 are examples of the submit assessment dialogue screens. Once a user completes all necessary data capture requirements, the submit assessment button appears on the assessment dashboard screen (see FIG. 26). Once the “Submit” button has been selected, a progress bar shows the time remaining and the data is received. When the submission completes, a message displays noting successful submission (see FIG. 27). In education use cases, the message specifies when the user can expect to see a final report returned to his mobile device application.

In some cases, a submission attempt fails; this could be the result of limited wireless coverage or the wildfire risk assessment provider server going down. In this instance, a “Submission Failure” note appears, giving the user an opportunity to re-attempt the submission. Once the “Submit Assessment” button option appears, it remains present and active until the user has successfully submitted the assessment.

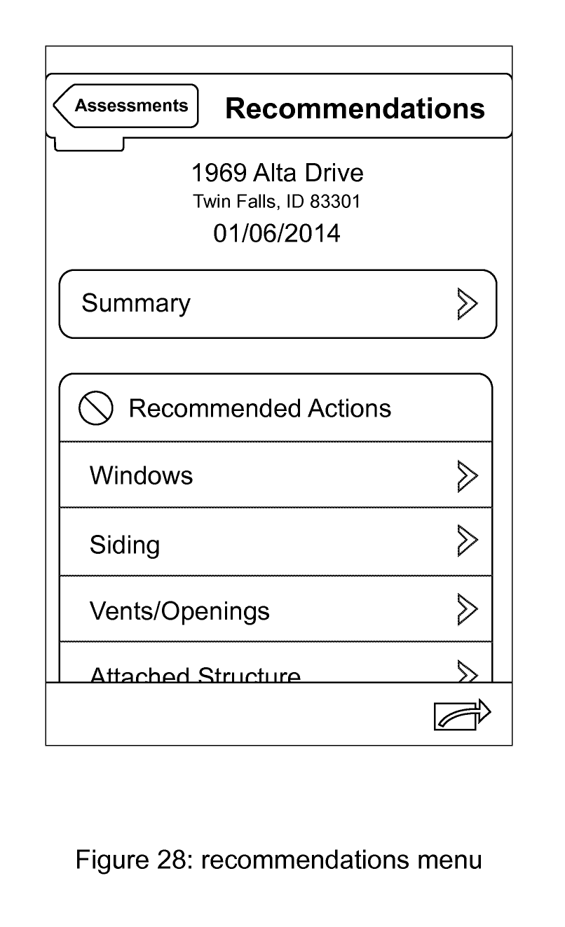

FIGS. 28-30 are examples of the summary and recommendation screens that are returned to the mobile device application. These typically only appear for education use cases and provide an opportunity for policyholders to gain insight on risks around their home and ways to mitigate them.

Once a report has “Completed” status at the wildfire risk assessment provider server—this typically occurs automatically in a level 1 service and is manually clue used by wildfire risk assessment provider staff for a level 2 service—the output is returned to the mobile device application. The user learns of this output return via a push notification received on the mobile device application that indicates the assessment is ready to be downloaded and viewed. When the user next re-visits the mobile device application, the report data is automatically downloaded and appears in the recommendations tab. To see recommendations, the user (typically a policyholder) clicks on the address, which now falls below a “Completed” header, shows as gray, and has a completed date. FIG. 28 shows the main menu of the recommendations tab.

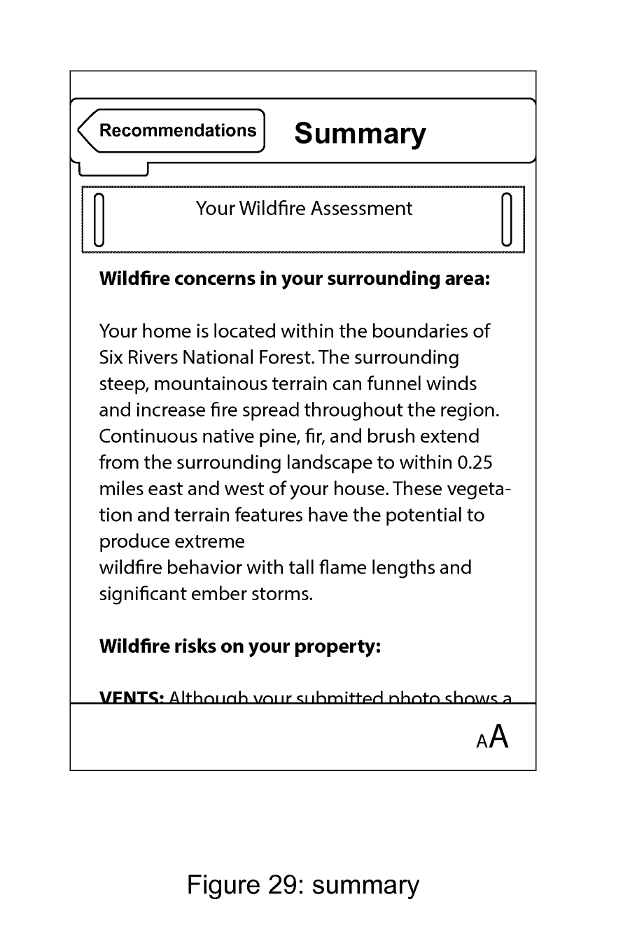

For users who receive a level 2 or level 3 service, a “Summary” option appears. When the user selects this option, a personalized write-up displays (see FIG. 29). This write-up is completed by a fire risk analyst at the wildfire risk assessment provider office and consists of a general area threat summary, as well as bullet-point recommendations for ways in which the user can mitigate risks around his home. These recommendations are based on analysis of photos that were submitted by the user and call upon specific home/property details in an attempt to make the suggestions more clear. The write-up is intended to be simple to understand and follow for users with varying levels of wildfire knowledge and to prompt the user to take action to reduce risk.

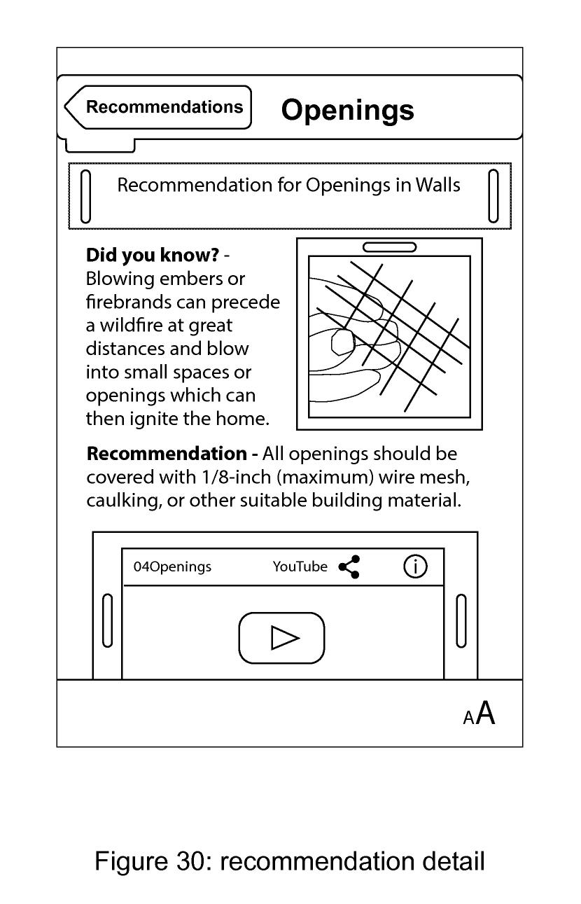

The recommended actions that appear are broken into orange “problem” risk conditions and blue “good” (no problem) conditions. Selecting any of these actions takes the user to more detailed information (see FIG. 30), which attempts to further clarify the risk with photos and videos. The user is able to print, email or view the completed report as an ADOBE ACROBAT™.pdf file.

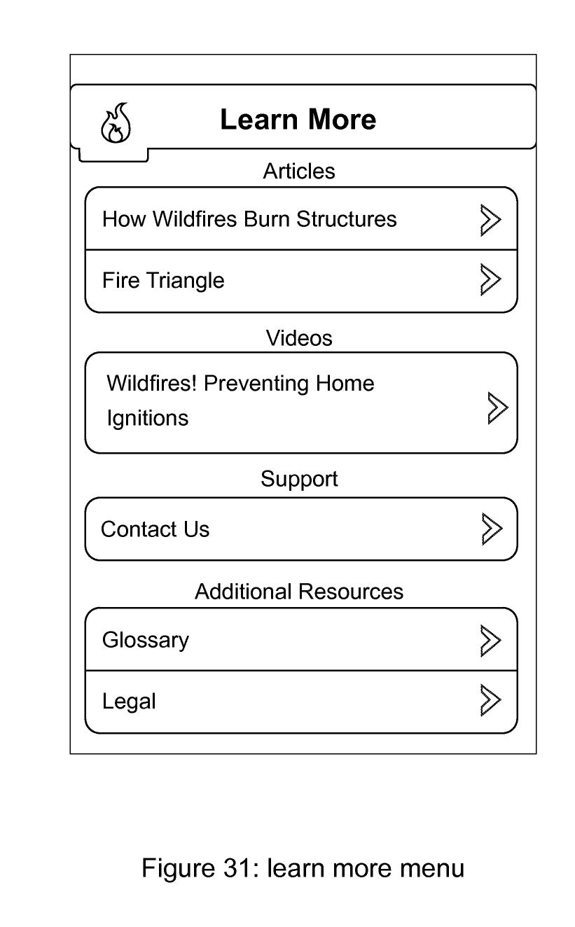

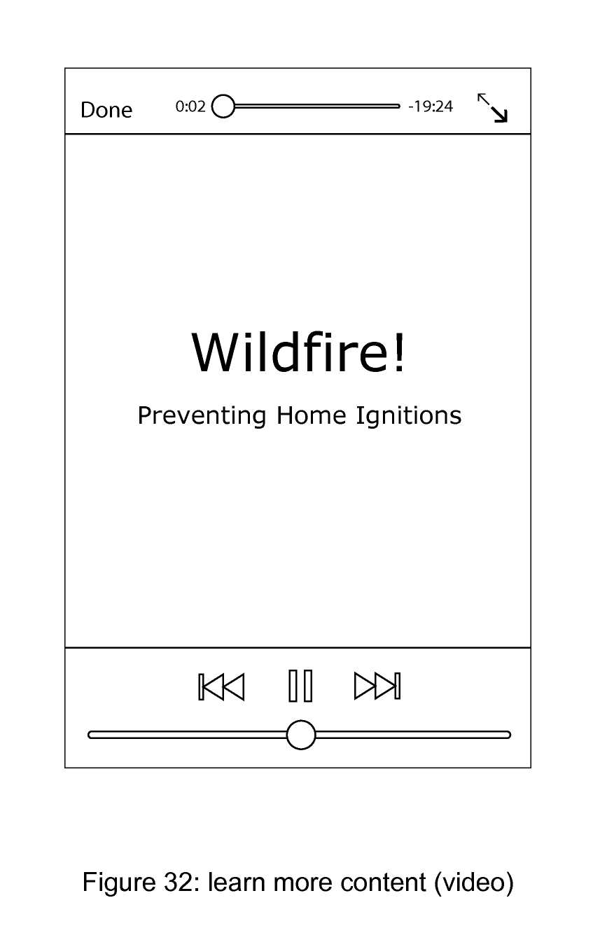

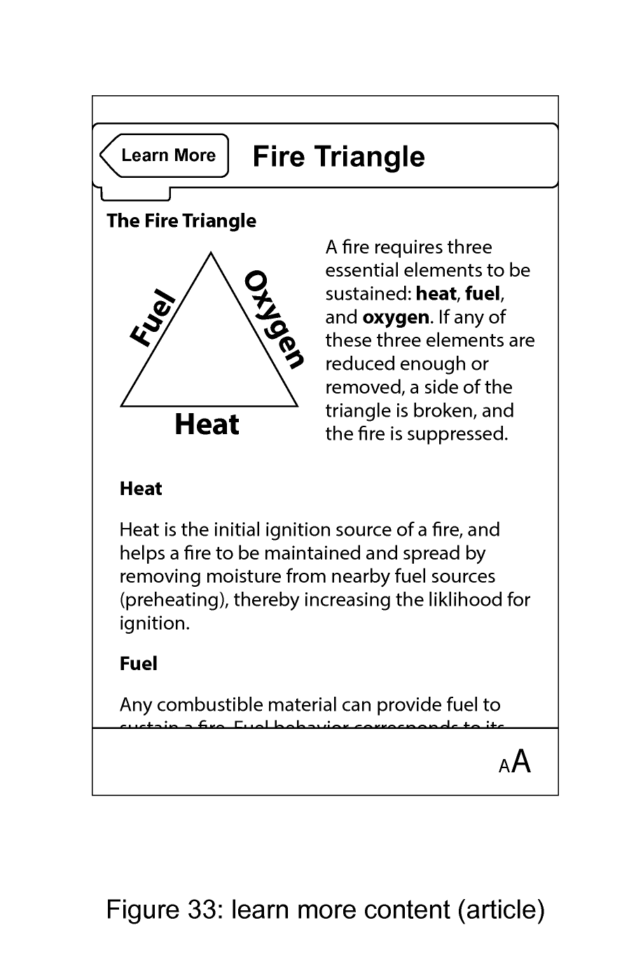

FIGS. 31-33 are examples of the learn more section of the mobile device application. This is an area that clients (in most cases, insurers) can use to collect useful reference material for their policyholders or staff. The learn more material is accessible from the learn more menu (see FIG. 31). This reference material is specific to user type; for instance, in the case of a policyholder (education use case), the reference might be wildfire risk and risk reduction videos (see FIG. 32) and/or articles (see FIG. 33), whereas in the case of a data collection staff employed by the insurer (underwriting use case), this reference might include on-property policy regulation documentation.

FIG. 51 is a diagram of the updated wildfire risk breakout. Wildfire risk factors typically follow seasonal patterns based on changing climactic conditions and, in a common scenario, are lowest in the winter and highest in the summer. Climactic conditions that can change to affect a given property threat include, but are not limited to, humidity, temperature and wind. A property's threat level increases in accordance with whether it is non-wildfire season, wildfire season, wildfire season with red-flag warnings affecting the area, and wildfire season with active wildfire (a wildfire burning within three miles of the property). Applying multipliers to these times indicates how exposure is increasing or decreasing through the year.

Non-wildfire season is the time of the year that historically does not show wildfire activity for a given area due to lowered climactic condition effects. Non-wildfire season has no additional impact on a site's vulnerability, and thus a multiplier of one (1) is used to show no change. During wildfire season—the start and stop of wildfire season is based on historical wildfire data—a property is at a heightened wildfire risk, and thus a multiplier of (2) is used to indicate increasing threat. During wildfire season, a given location may be issued a redoing warning by the United States National Weather Service, which indicates conditions are ideal for a wildfire ignition. In this case, a multiplier of three (3) is used to indicate increasing threat. During wildfire season when a wildfire ignites and is burning within three miles of a given property, the property is at heightened risk; in this case, a multiplier of four (4) is used to indicate increasing threat.

FIG. 49 in a diagram of the updated wildfire risk algorithm. This algorithm multiplies the updated wildfire risk multiplier (see FIG. 51) by the location-based risk value (see FIG. 48) to produce an updated wildfire risk value. For instance, a given property with a location-based risk value of 3 and an updated wildfire risk multiplier of 3 (wildfire season, red flag warning) would have an updated risk value of 9. Dependent upon client thresholds, this risk value can be used to define various kinds of actions that result; for instance, it could move the client to call the policyholder to attempt to enroll him into a wildfire response program, move the client/wildfire risk assessment provider to call the policyholder to share wildfire information with him, guide home site visits to gain site data or perform wildfire pre-suppression actions, etc.

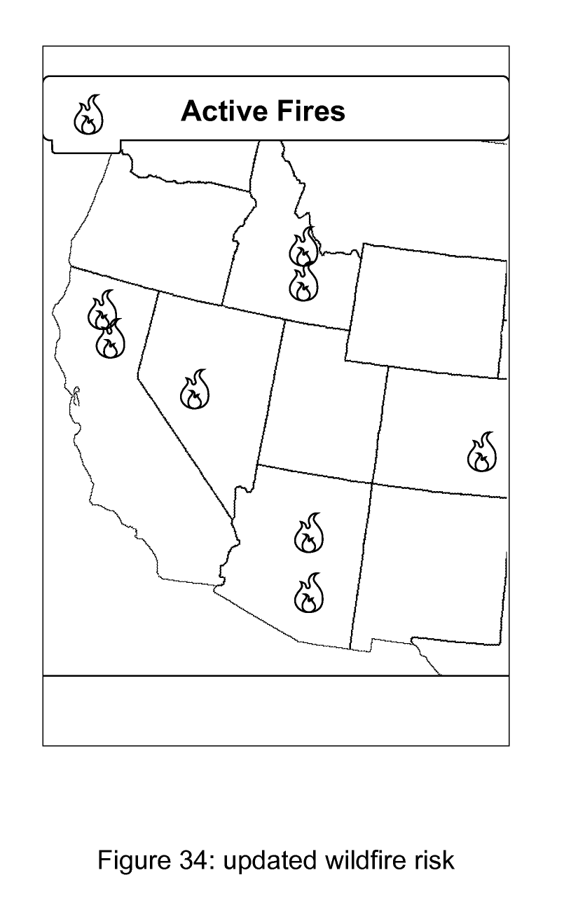

FIG. 34 is an example of the updated wildfire risk screenshot with a view set to only show active fires. This functionality allows users to browse current fire activity in a particular geographic map zoom and then navigate more deeply to learn about a given fire. In this example, users typically start by seeing an overview of the entire western United States, with fire graphics depicting map locations where an active fire is burning. Zooming in brings an area map into closer view, and touching any of the fire graphics brings up detailed information for the given fire. Additionally, the user can enter a longitude and latitude, zip code, city, or fire name into a search dialogue to bring up information regarding a given fire or fire location.

Once an active fire has been selected, the user receives detail in the term of a daily fire situation report and map. This situation report gathers information about a given wildfire's spread, expected growth/direction, areas a affected and areas threatened. Additionally, the user can read basic summary data about a given fire, including size, date(s) of activity, percent containment, etc.

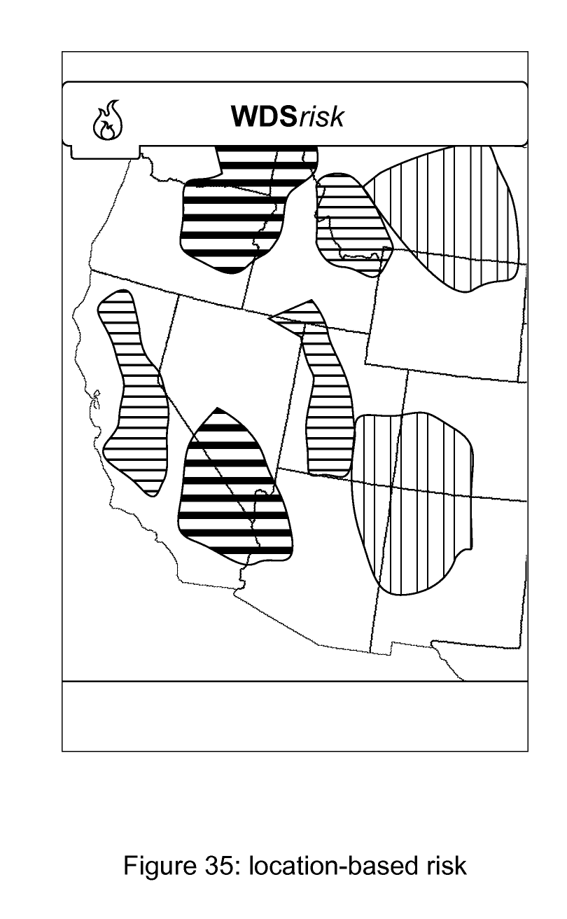

FIG. 35 is an example of the geographic location-based risk mapping. This view allows a user to see a spectrum of fire risk based on geographic location alone. Users start by seeing an overview of the entire West, with fire graphics depicting map locations where an active fire is burning. Zooming in brings an area map into closer view, and a user can drag the area of the map he warns to see into the center of the screen. The user can also enter a longitude and latitude, zip code, city, or fire name into a search dialogue in order to navigate to a given location.

A spectrum of colors indicating severity of threat allows users to see geographic fire risk broken down by various wildfire factors, including fire history, predominant vegetative fuel type, topography, climate, etc. This information would need to be multiplied by site data (site-based risk assessment) to obtain the full picture of a given property's risk.

FIG. 50 is a diagram of the integrated wildfire risk algorithm. This integrated wildfire risk value is generated using the integrated wildfire risk algorithm, which multiplies all known risk scores for a given property, specifically (a) site-based risk total, (b) location-based risk value, and (c) updated wildfire risk multiplier. For instance, if a given site had a site-based risk total of 3, a location-based risk value of 3 and an updated wildfire risk multiplier of 3, its integrated wildfire risk value would be 27 (3*3*3)=18.

The integrated wildfire risk score can be used by the client and/or wildfire risk assessment provider to determine a course of action for a wildfire response mission. Detail gathered in the site-based risk assessment can be used to aid on-the-ground efforts to locate the property, prepare for location-based risk factors at play, and define pre-suppression (pre-wildfire risk reduction) actions needed; for instance, a policyholder could be called and asked if he had moved firewood from his wood deck, as was identified as a site-based risk in the wildfire risk assessment previously completed. Integrated risk score thresholds can suggest a priority of property visit, as defined by the client. This integrated wildfire risk value cart also define policyholder outreach efforts, which may include attempts to communicate with the policyholder on the phone, via push notification using the mobile device application, and/or via email.

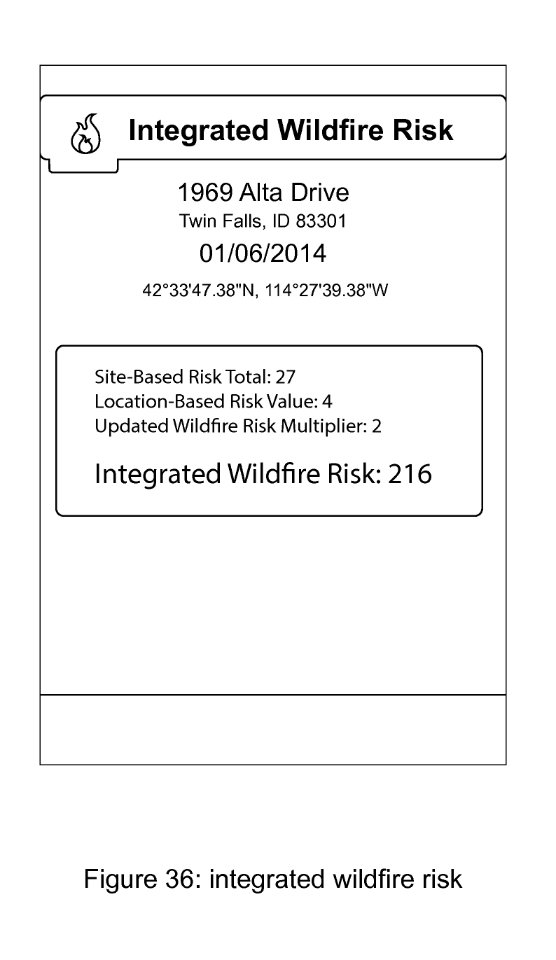

FIG. 36 shows an example of integrated wildfire risk analyses coming together to create the broadest, most cohesive picture of a property's fire risk. Values for (a) site-based risk, (b) location-based risk, and (c) updated wildfire risk are multiplied together to create a single integrated wildfire risk score. This integrated wildfire risk score can be used to determine a coarse of action for insurers and/or property owners.

Location-based risk value and updated wildfire risk multipliers are pre-populated (see FIG. 36). If the user has completed a site data collection, this information will pre-populate as well; if not, the user will be asked to gather this data before a final analysis can be viewed.

Upon successful completion of all risk items, the user is able to review an integrated wildfire risk analysis of the given property. This analysis may include mitigation recommendations, evacuation advice, etc., and the desired output is defined by the clients. The integrated wildfire risk value and analysis may be returned to the user's mobile device application, client server, and/or the wildfire risk, assessment provider server, depending upon the user type.

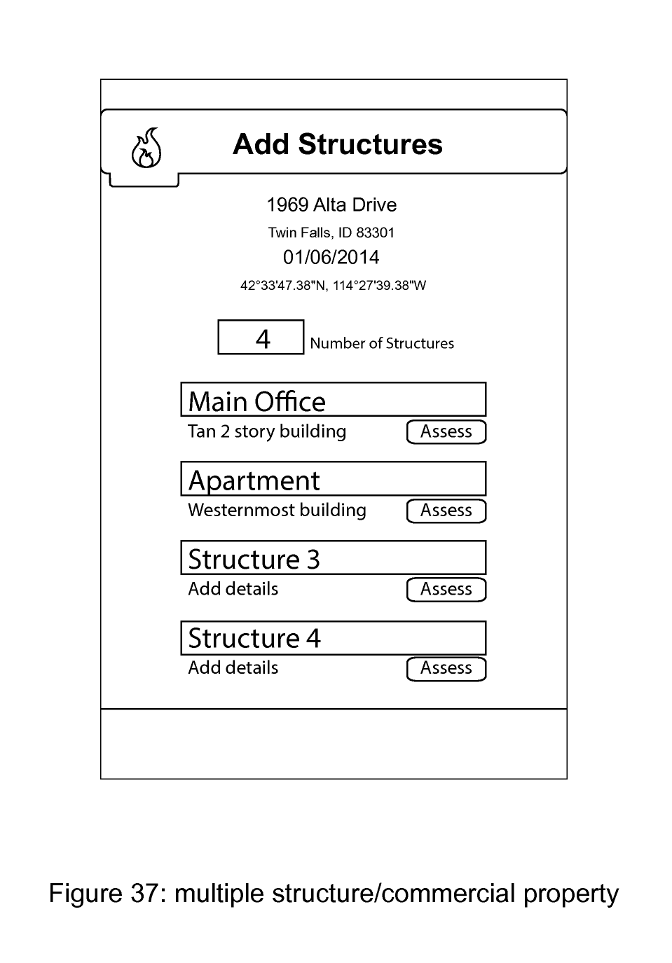

FIG. 37 is an example of the mobile device application add structure screen as designed for a commercial client. In this case, the mobile device application accommodates the data collection needs for multiple structures that may exist on a given property, and labeling identifies to which structure data is associated (for instance, a photo taken for the window on structure #1 is labeled “window-structure 1”). Commercial users are asked to specify the number of structures they are assessing on a given property. Each of these structures is given a default label—i.e., “Structure #1”—or can be named by the user—i.e., “West Units” The user may add notes to help further identify the structure's location, detail, etc.

From this point, the user walks through the data collection for each structure, which is specified at the top of the screen. Progress/completion dialogue clarifies for which of the structures data collection has been completed (and to what degree it is still outstanding).

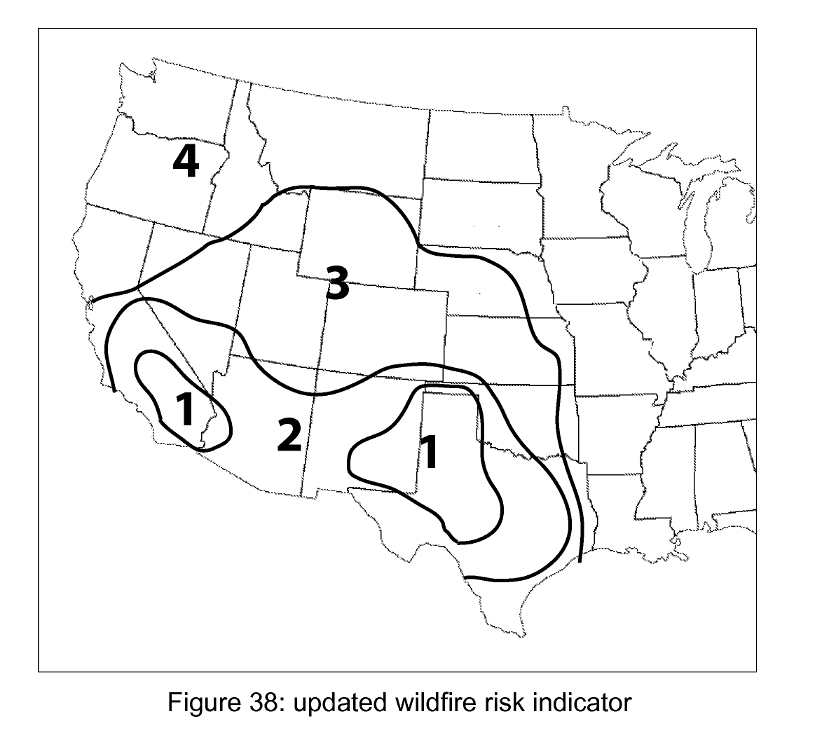

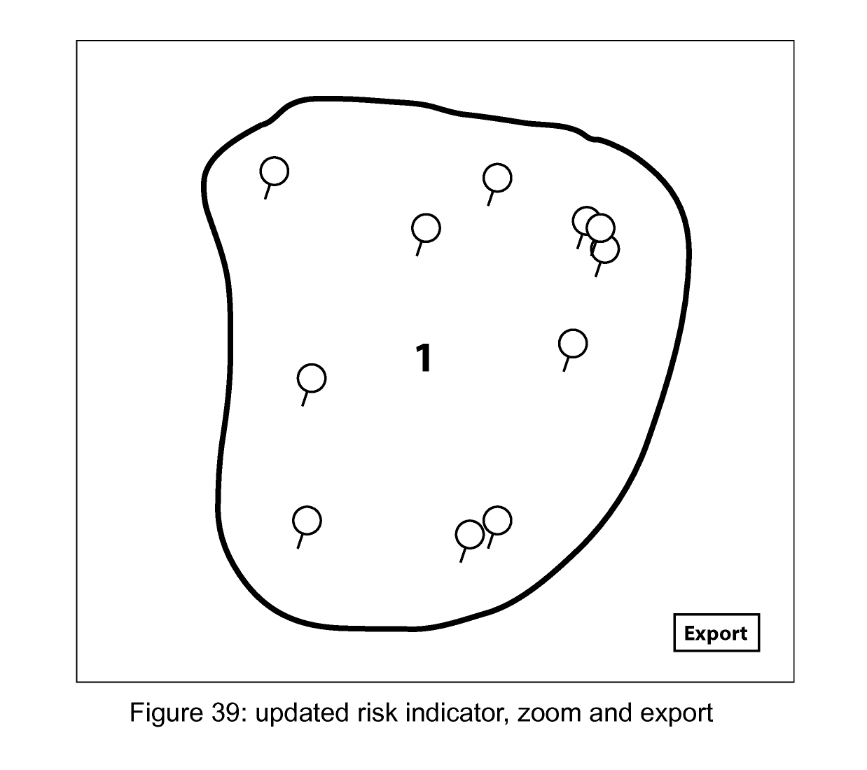

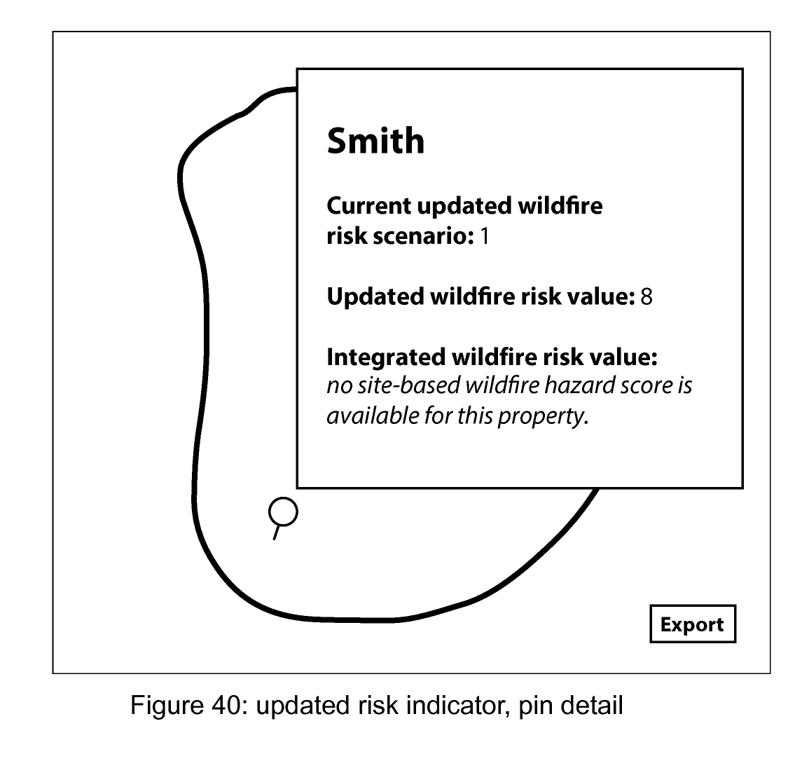

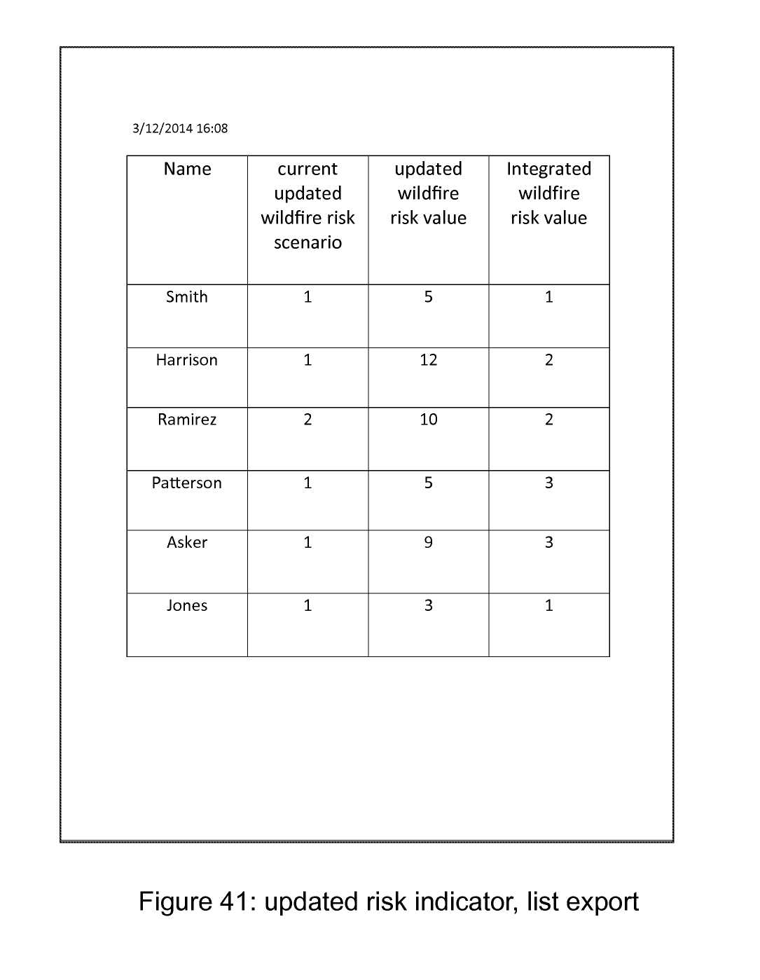

FIG. 38 is the updated wildfire risk, indicator screen, which is a view that can be seen both on the mobile application device (education users) and a web interface (for client users). This screen is updated daily to show wildfire status across a given geographic area, and potential wildfire risk values fall into four possible categories (see FIG. 51). Users are able to zoom in on this view (see FIG. 39) and once the user reaches a certain view magnification threshold, an option to export properties included in the zoom appears. Clicking “Export” generates a spreadsheet report (see FIG. 41) that lists any properties in the given zoom, updated wildfire risk score, and integrated wildfire risk score (assuming a site-based wildfire hazard report has been generated for that property). Additionally, a user can select a given property pinpoint to read the specific detail for that property location (see FIG. 40) on the mobile device application and/or the website interface to gain a quick snapshot view for the property.

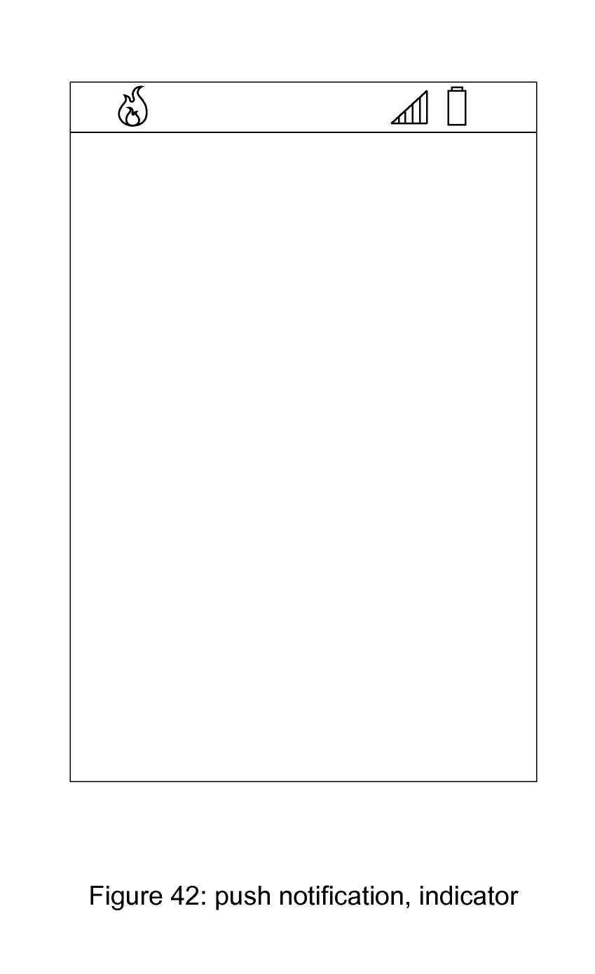

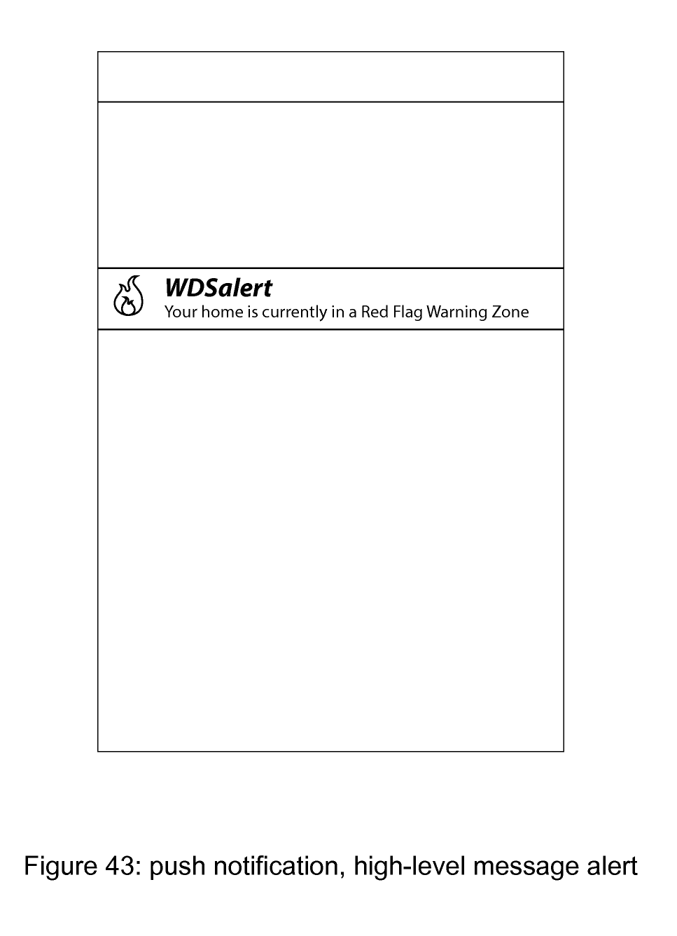

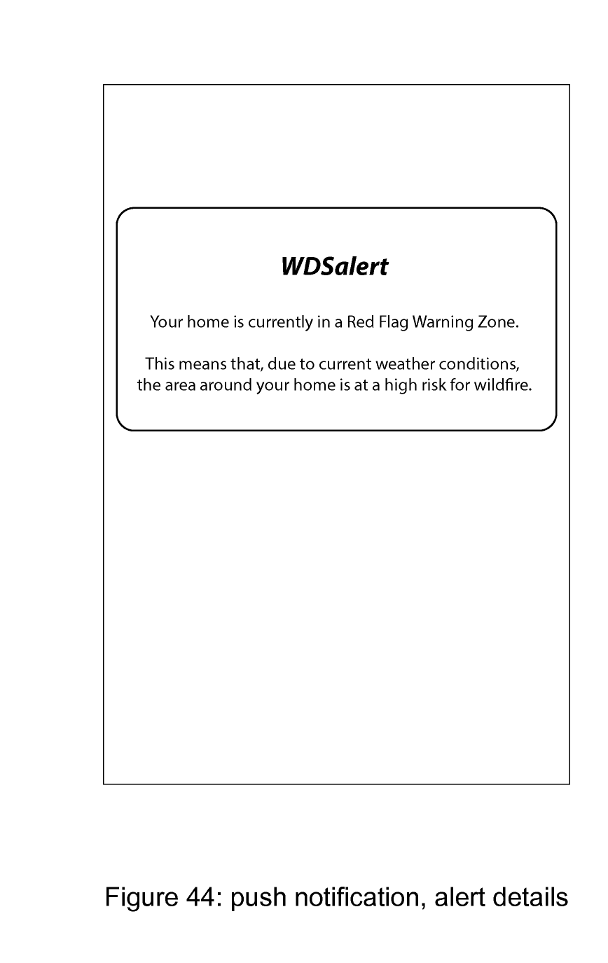

FIG. 42 shows a push notification indicator on a user's mobile device. This push notification is initiated when a given updated risk yields a threat value that the client has deemed warrants alert. Like other mobile application alerts, the user can navigate to the given alert and select it; this takes the user to the high-level message alert (see FIG. 43). Selecting this message alert opens it up to share details of the alert (see FIG. 44).

Although the preferred embodiment of the present invention has been shown and described, it will be apparent to those skilled in the art that many changes and modifications may be made without departing from the invention in its broader aspects. The appended claims are therefore intended to cover all such changes and modifications as fall within the true spirit and scope of the invention. All of the screenshots discussed above and shown in the drawings are intended to be examples only and are not intended to limit the claims in any respect.

We claim:

1. A computer-implemented system for collecting and assessing wildfire hazard data comprising:
(a) a mobile device with an application installed on the mobile device for on-site collection of wildfire hazard data; and
(b) a wildfire risk assessment provider server;
wherein data collected on the mobile device is merged with data at the wildfire risk assessment provider server to produce underwriting risk scores and reports for insurers, education-aimed recommendations and reports for policyholders, wildfire risk alerts for mobile device application users, strategies for client-to-policy holder wildfire awareness communication, and strategies for wildfire response teams used to drive pre-suppression and active fire actions.

2. The system of claim 1, wherein the merging of the data collected on the morale device with data at the wildfire risk assessment provider server is accomplished via the application of a she-based risk algorithm that calculates a site-based risk total based on affirmative answers to wildfire risk assessment condition questions, a location-based risk algorithm that computes a location-based risk value based on a multitude of wildfire risk factors known to impact a site's potential for wildfire ignition, a level of service algorithm that generates a level of service score based on the site-based risk total and the location-based risk, value, an updated wildfire risk algorithm that multiplies the location-based risk value by an updated wildfire risk multiplier to determine an updated wildfire risk value, and an integrated wildfire risk algorithm that multiplies the site-based risk total, the location-based risk value, and the updated wildfire risk multiplier by each other to produce an integrated wildfire risk score.

3. A computer-implemented method for collecting and assessing wildfire hazard data comprising:
(a) selecting properties for which an assessment needs to be completed;
(b) providing a mobile device on which is installed an application for collecting wildfire hazard assessment data;
(c) applying a site-based risk algorithm to the collected wildfire hazard assessment data to calculate a site-based risk total;
(d) using a location-based risk algorithm to generate a location-based risk value, wherein the location-based risk value is determined by computing a multitude of wildfire risk factors known to impact a site's potential for wildfire ignition; and
(e) using a level of service algorithm to multiply the site-based risk total by the location-based risk value to generate a level of service score.

4. The method of claim 3, further comprising the step of using an integrated wildfire risk algorithm to multiply the site-based risk total, the location-based risk value, and the updated wildfire risk multiplier by each other to generate an integrated wildfire risk score.

5. A computer-implemented method for collecting and assessing wildfire hazard data comprising;
(a) using a location-based risk, algorithm to generate a location-based risk value, wherein the location-based risk value is determined by computing a multitude of wildfire risk factors known to impact a site's potential for wildfire ignition; and
(b) using an updated wildfire risk algorithm to multiply the location-based risk value by an updated wildfire risk multiplier to generate an updated wildfire risk value.

6. The method of claim 3 or 5, whet via the level of service score is used to determine a coarse of action to be taken by wildfire risk assessment provider staff.

7. The method of claim 3 or 5, wherein the integrated wildfire risk score is used to produce underwriting risk scores and reports for insurers, education-aimed recommendations and reports for policyholders, wildfire risk alerts for mobile device application users, strategies for client-to-policyholder wildfire awareness communication, and strategies for wildfire response teams used to drive pre-suppression and active fire actions.

8. The method of claim 3 or 5, further comprising providing summary and recommendation screens that are returned to the mobile device application.
